(19) United States
(12) Patent Application Publication
(10) Pub. No.: US 2024/0169115 A1
(43) Pub. Date: May 23, 2024

(54) MODELING THERMAL AND MECHANICAL CANCELLATION OF RESIDUAL STRESS FROM HYBRID ADDITIVE MANUFACTURING BY LASER PEENING

(71) Applicant: NUTech Ventures, Lincoln, NE (US)

(72) Inventors: Michael Patrick SEALY, Lincoln, NE (US); Guru Charan Reddy MADIREDDY, Lincoln, NE (US); Mehrdad NEGAHBAN, Lincoln, NE (US)

(21) Appl. No.: 18/281,997

(22) PCT Filed: Mar. 24, 2022
(86) PCT No.: PCT/US2022/021710

§ 371 Date: Sep. 14, 2023

Related U.S. Application Data
(60) Provisional application No. 63/167,436, filed on Mar. 29, 2021.

(51) Int. Cl. G06F 30/20; B22F 10/31; B22F 10/37; B22F 10/50; B22F 10/85; B22F 12/90; B33Y 30/00; B33Y 40/00; B33Y 50/02

(52) U.S. Cl. CPC G06F 30/20; B22F 10/31; B22F 10/37; B22F 10/50; B22F 10/85; B22F 12/90; B33Y 30/00; B33Y 40/00; B33Y 50/02

(57) ABSTRACT

Additive manufacturing (AM) of metals can result in parts with unfavorable mechanical properties. Laser peening (LP) is a high strain rate mechanical surface treatment that hammers a workpiece and induces favorable mechanical properties. Peening strain hardens a surface and imparts compressive residual stresses improving the mechanical properties of a material. This disclosure describes systems, methods, and techniques for modeling laser peening of a part and determining when and where laser peening can be applied to layers of the part in order to improve the mechanical properties of that part.

### CROSS-REFERENCE TO RELATED APPLICATIONS

This application claims the benefit of priority under 35 U.S.C. § 119 to U.S. Provisional Application Ser. No. 63/167,436, filed Mar. 29, 2021, the entirety of which is incorporated herein by reference.

### STATEMENT OF FEDERALLY SPONSORED RESEARCH

This invention was made with government support under CMMI1846478 awarded by the National Science Foundation. The government has certain rights in the invention.

### TECHNICAL FIELD

This document describes devices, systems, and methods related to modeling additive manufacturing using laser preening.

### BACKGROUND

Additive manufacturing (AM) methods can use 3D printing techniques to form a part based on a computational model of such part. Some manufacturing techniques can be labor intensive and/or cause increases in manufacturing cycle time and costs. High tensile residual stresses and cracking can occur for parts or components that are formed using AM methods. Sometimes, residual stresses can be relieved using heat treatments. Such heat treatments may not harden material (e.g., by grain boundary refinement, precipitation hardening, or martensitic transformation), which can be material/composition dependent and may not be necessarily agreeable with AM alloys. Such heat treatments may not be amenable to different types of materials. Moreover, such heat treatments may favor compressive residual stresses, which can be concurrently removed from a system along with tensile residual stresses.

Sometimes, cracking and wear in AM parts can be delayed by case hardening a surface with peening, burnishing, nitriding, or carburizing. Such external surface treatments can have a low penetration depth of hardening that can range from a few microns to a few millimeters. Bulk mechanical properties can remain unchanged.

Laser peening is a surface engineering process that can be used to impart beneficial residual stresses in materials. Peening can be done in intervals, such as at every fifth layer, every tenth layer, etc. Penning can also be performed randomly. Penning may be more needed in certain regions of layers.

Laser peening solutions may not be at fixed intervals for different types of problems. A laser peening solution to a corrosion or fatigue problem indicating which layers should be peened can appear more random. In fact, complex geometries or multiaxial loading can require peening in regional zones or domains. Understanding mechanical and material behavior can be difficult and time consuming. Highly heterogeneous compositions formed by cyclic printing and peening can be difficult to measure due to a lack of instrument resolution or high cost in terms of time and money.

Corrosion damage can be a factor affecting durability and safety of structures. Mathematical models for modeling corrosion progression can describe a propagation process of an individual corrosion site. Such models can be based on diffusion laws and electrochemical kinetics laws, and deliver geometrical evolution of a corrosion pit and concentration of dissolved ions throughout the corrosion site. Cellular automata (CA) techniques can also be used to model corrosion. Such models can mimic roughening of a reaction front. A finite volume method can also be used to capture evolution of diffusion and activation-based pitting corrosion. Such models can be based on diffusion in the solution, with a chemical reaction considered to only happen on the reaction front (a mathematical surface at the solid/liquid interface). Such models can predict a corrosion rate and capture roughening of a corrosion surface. However, since these models consider that the corrosion reaction only affects a metal surface (zero thickness layer), these models cannot capture microstructural changes in mechanical properties in subsurface layers immediately below the solid/liquid interface that take place in alloys. These changes, such as stress-dependence of the diffusion processes in corrosion, determine how stress corrosion cracking can be triggered and how it progresses in time. Stress corrosion (dependence of corrosion rates on stress) and stress corrosion cracking (cracking in a corrosive environment) can be determining factors for a remaining strength of a sample under combined loading and corrosive conditions with residual stresses embedded in the material. Stress corrosion cracking can be attributed to mechanisms such as anodic dissolution and cleavage. Dissolution at a passive film-free crack tip can lead to crack advancement. In cleavage, an embrittled region can form ahead of the crack tip, a crack can grow through the embrittled region and then can arrest as it enters a more ductile bulk material. Dependence of corrosion rate on stress or presence of residual stresses and their influence of crack growth may not be analyzed in the models described in this paragraph.

### SUMMARY

The document generally describes systems, methods, and techniques for hybrid additive manufacturing (AM). To improve service life of an AM part, the hybrid AM described herein can increase penetration depths during laser peening beyond some external surface treatments. The hybrid AM can provide for control of work hardening and residual stress throughout an entire build volume of a part rather than only an external surface of the part. Thus, the disclosed technology provides for layer-by-layer laser peening during AM, which can influence local mechanical properties and behavior. More specifically, the disclosed technology provides for a computational model to determine which layers (e.g., components) in a 3D part and where in a build volume of that part to execute a secondary surface treatment for a given type of problem (e.g., corrosion, fatigue, wear, static failure). Manufacturers and/or other users can be provided with information or instructions for forming a part during AM. Information or instructions can include which layers and targeted locations where a secondary surface treatment can be applied to solve the given type of problem. The disclosed technology can be advantageous to mitigate, prevent, or resolve different types of problems, such as corrosion, fatigue, wear, or static failure that can develop when building a part during the AM process. A high fidelity model can enable robust optimization in multi-process asynchronous hybrid additive manufacturing (MAHAM).

The disclosed technology can provide cyber manufacturing tools to access individual layers of a part during additive manufacturing, thereby enabling design opportunities for materials and manufacturing to print functionality. Using the disclosed technology, users can better understand compound mechanics whereby stress entanglement from intermittent laser peening of individual layers during printing can influence corrosion kinetics. Corrosion of magnesium is an example problem in compound mechanics because of challenges associated with rapid uncontrolled corrosion that can hinder performance in biodegradable implants, dissolvable plugs for oil and gas fracking, and naval aircraft components exposed to salt spray.

Thus, this disclosure can focus on modeling residual stress and microstructure formation and resulting corrosion behavior from MAHAM. MAHAM can be defined as using AM with one or more secondary processes or energy sources that can be fully coupled and synergistically affect part quality, functionality, and/or process performance. Layer-by-layer laser peening (LP) can be used during AM to influence local mechanical properties and global behavior.

In some implementations, temporal and spatial residual stress development for a build volume including multiple layers formed by hybrid AM can be modeled using a finite element analysis model. A generated residual stress model can evaluate thermal and mechanical cancellation caused by cyclical coupling of 3D printed layers and surface treatment processes, such as laser peening, that can be applied to a portion of a surface of one or more of the multiple layers. In some implementations, a residual stress model can be a two dimensional (2D) finite element model that can determine, for a given hybrid manufacturing-based layer structure, which of printed layers and what regions of the printed layers can be treated using a surface treatment process, such as laser peening, in a build volume.

In addition to the embodiments of the attached claims and the embodiments described above, the following numbered embodiments are also innovative.

Embodiment 1 is a computer-implemented method for simulating properties of a part formed during additive manufacturing, the method comprising: simulating, by a computing system, formation of a first layer of a computer-modelled part during an additive manufacturing process, including by assigning, to first nodes of a first layer of nodes of a collection of nodes that represents the computer-modelled part, respective first temperature values based on heat produced by a simulated melt pool created by a high-energy source; simulating, by the computing system, thermal cancellation of mechanical stresses within the first layer of nodes, including by modifying values of first stresses among the first nodes of the first layer of nodes based on the first temperature values of the first layer of nodes to form modified values of the first stresses; simulating, by the computing system, laser peening a surface of the first layer of the computer-modelled part, including by modifying the modified values of the first stresses among the first nodes of the first layer of nodes to form further modified values of the first stresses based on simulated pressure pulses produced by the simulated laser peening of the surface of the first layer of the computer-modelled part; and generating, by the computing systems, instructions for building the computer-modelled part during a real-world additive manufacturing process based on the simulating of the formation of the first layer of the computer-modelled part and the simulating of the laser pending of the surface of the first layer of the computer-modelled part.

Embodiment 2 is the method of embodiment 1, wherein assigning the first temperature values to the first nodes of the first layer of nodes includes assigning a particular temperature value to a particular first node from the first layer of nodes based on: heat from the simulated melt pool being located at a first position during the formation of the first layer; and heat from the simulated melt pool being located at a second position during the formation of the first layer.

Embodiment 3 is the method of any one of embodiments 1 through 2, wherein simulating the formation of the first layer of the computer-modelled part includes the simulated melt pool moving in a pattern to form the first layer of the computer-modelled part.

Embodiment 4 is the method of any one of embodiments 1 through 3, wherein modifying the values of the first stresses among the first nodes of the first layer of nodes includes decreasing the values of the first stresses to form the modified values of the first stresses.

Embodiment 5 is the method of any one of embodiments 1 through 4, wherein modifying the modified values of the first stresses includes to form the further modified values of the first stresses is based on (i) a first pressure pulse at a first location at the surface of the first layer of the computer-modelled part, and (ii) a second pressure pulse at a second location at the surface of the first layer of the computer-modelled part, such that a particular stress of the first stresses has a further modified value that is based on both the first pressure pulse and the second pressure pulse.

Embodiment 6 is the method of embodiment 5, wherein an effect of the first pressure pulse on the particular stress is based on a first distance from the particular stress to the first location; and an effect of the second pressure pulse on the particular stress is based on a second distance from the particular stress to the second location, the second distance being different from the first distance.

Embodiment 7 is the method of any one of embodiments 1 through 6, wherein the modified values of the first stresses are in tension, resulting from heat produced by the simulated melt pool; and the further modified values of the first stresses are in compression, resulting from the simulated pressure pulses.

Embodiment 8 is the method of any one of embodiments 1 through 7, comprising: simulating, by the computing system, formation of a second layer of the computer-modelled part on top of the first layer of the computer-modelled part, including by assigning, to second nodes of a second layer of nodes of the collection of nodes that represents the computer-modelled part, respective second temperature values based on heat produced by the simulated melt pool during formation of the second layer; simulating, by the computing system, thermal cancellation of mechanical stresses within the second layer of nodes, including by modifying values of second stresses among the second nodes of the second layer of nodes based on the second temperature values of the second layer of nodes to form modified values of the second stresses; and simulating, by the computing system, laser peening a surface of the second layer of the computer-modelled part, including by further modifying the modified values of the second stresses among the second nodes of the second layer of nodes to form further modified values of the second stresses based on simulated pressure pulses produced by the simulated laser peening of the surface of the second layer of the computer-modelled part.

Embodiment 9 is the method of embodiment 8, comprising: assigning, by the computing system after simulating the formation of the second layer, updated first temperature values for the first layer based on heat produced by the simulated melt pool during formation of the second layer; modifying, by the computing system after simulating the formation of the second layer, the further modified values of the first stresses to form updated values of the first stresses, based on: (i) the further modified values of the first stresses, and (ii) heat produced by the simulated melt pool during formation of the second layer; and modifying, by the computing system after simulating the formation of the second layer, the updated values of the first stresses to form further updated values of the first stresses based on: (i) the updated values of the first stresses, and (ii) simulated pressure pulses produced by the simulated laser peening of the surface of the second layer of the computer-modelled part.

Embodiment 10 is the method of any of embodiments 1 through 9, comprising modifying values of lower-layer stresses of a lower layer of nodes multiple layers below the first layer of nodes in the collection of nodes to produce modified values of the lower-layer stresses, based on the simulated pressure pulses produced by the simulated laser peening of the surface of the first layer of the computer-modelled part, wherein the modified values of the lower-layer stresses are lower than the values of the lower-layer stresses due to mechanical cancellation of the lower-layer stresses resulting from the simulated laser peening of the surface of the first layer of the computer-modelled part.

Embodiment 11 is a computerized system for simulating properties of a part formed during an additive manufacturing process, the system comprising: one or more processors; and one or more computer-readable devices including instructions that, when executed by the one or more processors, cause the computerized system to perform the method of any one of embodiments 1 through 10.

The devices, system, and techniques described herein may provide one or more of the following advantages. For example, a computational model as described herein can be advantageous to simulate additive manufacturing of a part and associated laser peening or other secondary processes. By modeling the additive manufacturing and laser peening process, the disclosed technology can provide for improving design opportunities. Improved design opportunities can provide for building parts during an additive process and avoiding problems such as corrosion, fatigue, wear, and static failure.

As another example, the disclosed technology can provide for simulation, verification, and optimization of peening patterns through implementation of real-time MAHAM. MAHAM combines AM with one or more secondary processes or energy sources that can be fully coupled and synergistically affect part quality, functionality, and/or process performance. As described herein, the secondary processes can include machining, laser reprocessing, laser peening, and mechanical surface treatments. Fully coupling such processes can distinguish pre- and post-processing of a part build from those processes required during a part build, often layer-by-layer (or multiples thereof). Synergy refers to enhanced outcome(s) from coupling one or more secondary processes that may not be achievable when uncoupled. In MAHAM, the part, the process, and/or the part's functionality can experience enhancement(s) from fully coupling two or more processes.

Moreover, the disclosed technology can provide a high fidelity model to understand stress entanglement from interlayer peening. Mechanical properties can also be improved to denote where laser peening may be necessary for a part. Fatigue damage can be evaluated by finite element analysis modeling. Furthermore, overall analysis time can be reduced by taking large loading steps in an entire loading process.

As another example, interlayer peening during printing cold works individual layers and can result in improved surface finishes, refined microstructures, reduced distortion, increased hardness, higher densities, and favorable compressive residual stresses. Coupling AM with layer-by-layer laser peening can manipulate bulk mechanical properties to improve service life of parts. Further, cold working layers during printing can improve toughness by imparting a complex glocal (e.g., local with global implications) integrity across pre-designed internally reinforced domains. Glocal integrity can refer to a cumulative surface integrity enabled by secondary processing of individual layers during printing. For example, laser peening during 3D printing can impart cold worked regions, which can evolve and interact with each other as a build progresses. These interactions can entangle compounding residual stress fields and produce complex microstructures.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a schematic diagram of a hybrid additive manufacturing (hybrid-AM) process using directed energy deposition (DED) and laser peening (LP).

FIG. 2 is a schematic diagram representing thermal cancellation of compressive residual stress caused by heat from printing a new layer on top of a previously peened layer of a part.

FIG. 3 is a schematic diagram representing mechanical cancellation of compressive residual stress caused by peening a new layer on top of a previously peened layer.

FIG. 4 depicts a table of an example heat flux model.

FIG. 5 is a graphical depiction of a pressure-time profile of a single laser peening process.

FIG. 6 is a schematic diagram of a hybrid AM model with thermal and mechanical boundary conditions.

FIG. 7 is a graphical depiction of variation of pressure with respect to time during a laser peening process.

FIG. 8 is a flowchart for a simulation process of hybrid AM by laser peening.

FIG. 9 is a graphical depiction of example stress profile comparisons of hybrid AM models.

FIG. 10 illustrates example residual stresses developed in layers in each hybrid AM model of FIG. 9.

FIG. 11 is a graphical depiction of a temperature profile with time at a top center of a substrate.

FIGS. 12A-B are graphical depictions of stress profile evolution of a hybrid AM model with laser peening on every 10 layers.

FIG. 13 is a graphical depiction of stress profile evolution of a hybrid AM model with laser peening on every 5 layers.

FIG. 14 is a graphical depiction of stress profile evolution of a hybrid AM model with laser peening on every layer.

FIG. 15 is a step historic of residual stresses at an element in surface peened, hybrid AM with laser peening at every 10 layers, hybrid AM with laser peening at every 5 layers, hybrid AM with laser peening at every layer models and a location of the element at an interface of a baseplate and build.

FIG. 16 is a conceptual diagram of a system for simulating properties of a part formed during an additive manufacturing process.

FIGS. 17A-D depict a flowchart of a process for simulating properties of a part formed during an additive manufacturing process.

FIG. 18 is a schematic diagram that shows an example of a computing device and a mobile computing device.

Like reference symbols in the various drawings indicate like elements.

### DETAILED DESCRIPTION OF ILLUSTRATIVE EMBODIMENTS

This document generally relates to systems, methods, and techniques for understanding how interspersing cold worked layers during additive manufacturing (AM) of magnesium alloys can form new materials with compound mechanical properties that inhibit further plastic flow, failure/fracture and corrosion. The disclosed technology provides an integrated computational framework that couples peridynamics with finite element modeling of AM and peening using a plasticity-based algorithm. Flexibility in peridynamic modeling can be advantageous to understand arbitrary damage configurations, ranging from distributed damage to localized cracks. Therefore, the disclosed technology can provide a computational model to understand which layers and where asynchronous processing can be needed for a given design problem. Corrosion of magnesium alloys is an example design problem.

As described herein, the disclosed technology can provide for 3D simulations to predict residual stress and microstructure form interlayer peening. Local and global material loaded, material addition, and transformations (e.g., corrosion) can be integrated in a quantitative tool. The disclosed technology can capture processes of addition, transformation, local interaction, and patterned plastic intervention through a software-based tool. A cyber-based multi-process asynchronous hybrid additive manufacturing (MAHAM) can be provided for integrating with a two-way multi-scale peridynamics simulation to model mechanical/chemical interaction in corrosion or other design problems. For example, the disclosed technology can be used to control initial global warping and predict local residual and plastic strains accurately for different MAHAM interventions. The disclosed software-based tool can also provide methods, techniques, and procedures for experimentally measuring anisotropic and heterogeneous residual stress in complex MAHAM patterns. Such methods, techniques, and procedures are advantageous because they can be alternative techniques to neutron or x-ray diffraction, which lack measurement resolution or accuracy at reasonable penetration depths.

Coupling printing and peening introduces manufacturing challenges referred to as thermal and mechanical cancellation. Thermal cancellation refers to loss of favorable residual stress from heat when printing on top of a peened layer. Mechanical cancellation refers to loss of favorable residual stresses from undesirable stress redistribution when peening on top of previously peened layers. Moreover, peening in MAHAM can produce large plastic flow in patterns between and within layers in AM, resulting in a complex distribution of plastic flow and residual stress. This can change and interact with the ongoing AM process, further peening, and boundary constraints. Resulting distributions of residual stress and microstructure subsequently can influence corrosion, locally accelerating or decelerating it in addition to a commonly considered influence of diffusion. Simulation of plastic flow can be inherently computationally time intensive and can become unstable when solving boundary value problems.

Since laser peening can introduce residual stresses that change a corrosion rate or other design problem, the disclosed technology incorporates stresses as input. Residual stresses can be introduced in modeling techniques described herein by modifying a constitutive model for bonds. For example, a compressive residual force can be represented by a corresponding “shift” in a force-displacement functional relation. Measured residual stresses can be inputted in the model, and these can be orientation dependent. Presence of residual stresses can influence growth direction of cracks in a part, thus affecting remaining strength of the part. The disclosed technology, which can be process integrated compound mechanics (PIC-ME), can therefore integrate process modeling, heterogeneous property formation, interactive multi-scaling, and local peridynamics to connect events in layered peening during additive manufacturing with local plastic intervention and underlying physics that can dictate influence of processing on operational life. A high fidelity asynchronous cyber manufacturing platform as described herein can melt and integrate high-performance computing, process modeling, interactive property evolution, an adaptive multi-scale connection to lower scale physical events. Using the disclosed technology can provide for improved design of metal material devices and can predict factors influencing material degradation and failure of such devices. Initial residual stress profiles can be determined such that a laser peening process (e.g., laser power, overlapping ratio, layers) during printing can be automatically adjusted to produce desired residual stress profiles.

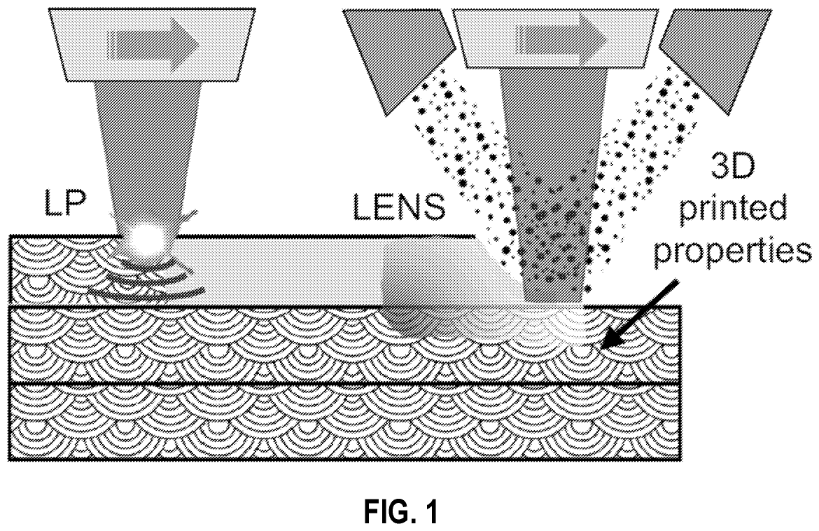

Referring to the figures, FIG. 1 a schematic diagram of a hybrid additive manufacturing (hybrid AM) process using directed energy deposition (DED) and laser peening (LP). As shown in FIG. 1, one or more layers can be added to a part. Laser peening can then be applied to portions of the part. In hybrid AM, a primary AM process can be directed energy deposition (DED), powder bed fusion (PBF), or sheet lamination. In DED, metal powder can be blown into a melt pool created by a dense, high energy heat source (e.g., laser or electron beam) and deposited as a layer of a part. In PBF, a scanning laser can melt stationary powder particles to form a layer of a part. Sheet lamination can stack sheets of metal that can be bonded together using ultrasonic welding. 3D mechanical properties achieved by coupling printing with laser peening can be dependent on AM process mechanics. As described herein, laser engineered net shaping can be coupled with LP as a secondary layer-by-layer process.

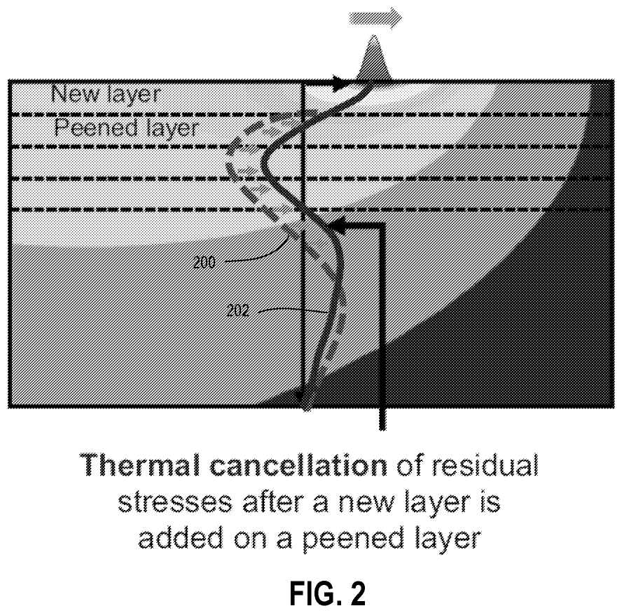

FIG. 2 is a schematic diagram representing thermal cancellation of compressive residual stress caused by heat from printing a new layer on top of a previously peened layer of a part. In hybrid AM, thermal cancellation can occur when the new layer is added on top of an already peened surface. As depicted in FIG. 2, dashed and solid lines represent residual stress profiles after peening and after printing, respectively. Line 200 depicts a level of strain before laser peening. Once laser peening is applied, the line 200 peaks and stresses can loosen up. Line 202 therefore represents the stresses loosing up after the laser peening is applied. Heat generated during material deposition can cancel beneficial mechanical properties previously induced by peening. This phenomenon of eliminating or reducing the magnitude of favorable compressive residual stresses from an AM heat source is referred to as thermal cancellation. Naturally, thermal cancellation can be dependent on AM process parameters and corresponding heat entering the part. A degree of sensitivity can depend on a material being printed and its related thermal properties.

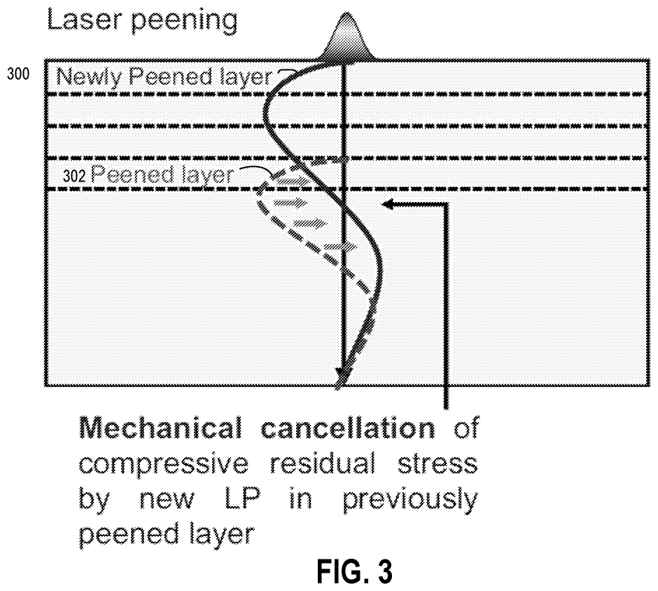

FIG. 3 is a schematic diagram representing mechanical cancellation of compressive residual stress caused by peening a new layer 300 on top of a previously peened layer 302. Mechanical cancellation in hybrid AM can be a reduction of compressive residual stresses present below a surface of a part due to application of peening on subsequent layers. The dashed and solid lines depicted in FIG. 3 represent residual stress profiles after peening different layers. Since peening induces both compressive and tensile residual stresses below the surface of the part, peening new layers (e.g., layer 300) on top of previously peened layers (e.g., layer 302) can redistribute residual stress fields. A tensile component of peening the new layer 300 can redistribute a compressive residual stress from peening the previous layer 302.

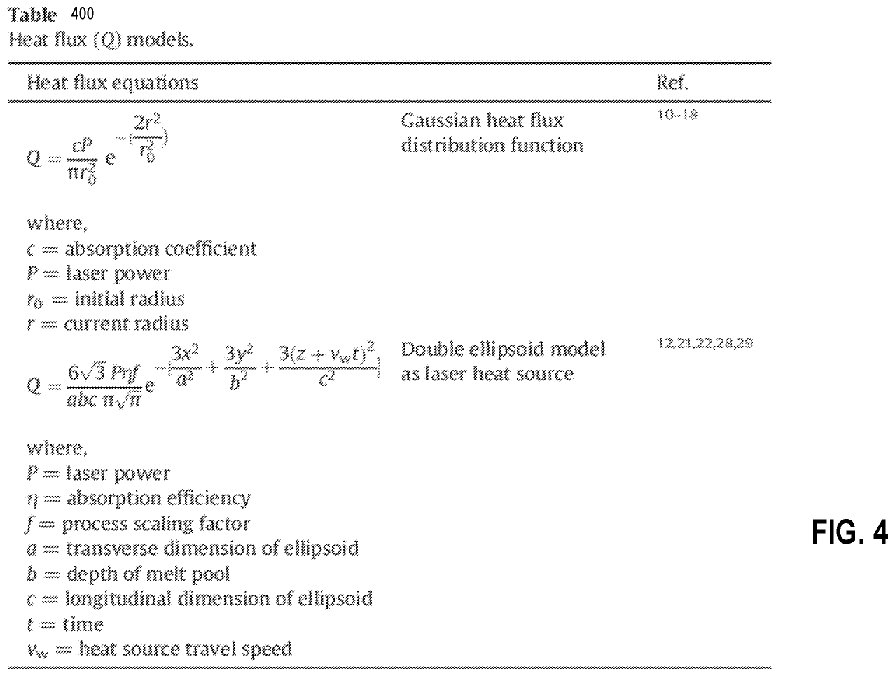

FIG. 4 depicts a table 400 of an example heat flux model. DED is an AM process in which focused thermal energy fuses materials by melting as layers are being deposited. In DED, metal powder or filament can be melted and deposited by focused thermal energy from a laser beam, electron beam, or plasma arc. Residual stress can develop and evolve with addition of layers that affects mechanical properties and subsequent performance. Modeling tools can be used to understand and predict residual stress development across different materials systems and machine platforms. Some components that can be used to model DED include a moving thermal source (e.g., laser or electron beam), a technique for adding new layers, boundary conditions, and a temperature dependent material model. Example DED processes can be modeled with LENS®, direct laser metal deposition (DLMD), shape metal deposition (SMD), and laser cladding.

The thermal energy source during DED can be modeled with a heat flux. Heat flux models can be used across multiple thermal processes, such as LENS®, laser cladding, laser metal deposition, and welding processes. Table 400 depicts a Gaussian distributed function, which can be used for heat flux. This function can be used to adapt a melt pool by changing variables in the Gaussian function. A size of the melt pool is represented by a radius r. The constant c represents effects of reflectivity, beam distribution parameter, and absorptivity of the material. For 3D models, the parameter r² can change to r²=x²+y².

Another heat flux model is a double ellipsoid, also depicted in table 400. This model can be easily changed to represent both shallow penetration of an arc in welding and deeper penetration from laser and electron beam processes. Constants α, b, and c define melt pool dimensions, and these values can be different for front and rear ellipsoids. The constants depend on specific heat source and material being modeled.

In order to model layer addition during DED, a quiet element method and/or an inactive element method can be used. In the quiet element method, unprinted elements are present in a model but can be assigned reduced material properties. These properties can be obtained by multiplying with a scaling factor. Elements with reduced properties may not affect analysis. As the analysis progresses and these quiet elements are ready to be “printed,” realistic material properties can be assigned to quiet elements in order to establish their presence in the model. Inactive element is another approach similar to the quiet element method. However, the difference is that deposited elements can be deactivated at a beginning of the analysis. Elements can be activated in each step individually, or as a layer, as a heat source acts upon each layer.

In DED, it can be important to have boundary conditions to accurately calculate temperatures developed in layers during material deposition. These boundary conditions can influence an amount of heat passing through a system and can influence an amount of residual stress and distortion present in a part. Boundary conditions depend on a type of DED process. For example, electron beam melting takes place in a vacuum, where heat transfer occurs only through conduction in a material and radiation on a surface of the build. Whereas in processes such as LENS®, laser cladding, and DLMD, powder material can be blown into a melt pool through inert gas. The flow of inert gas over the melt pool acts as forced convection. Another boundary condition to be considered is heat transfer from deposited layers to a substrate below.

Due to thermal characteristics of DED, temperature-dependent properties of a material can be incorporated into a simulation. These temperature-dependent properties account for phase transformation, melting, and re-solidification of the material. The transformation of material from liquid phase to solid phase can be defined by latent and specific heat, respectively. Other mechanical properties, such as a temperature dependent elastic modulus or thermal expansion, can be used to determine stresses and deformations developed in a model due to deposition.

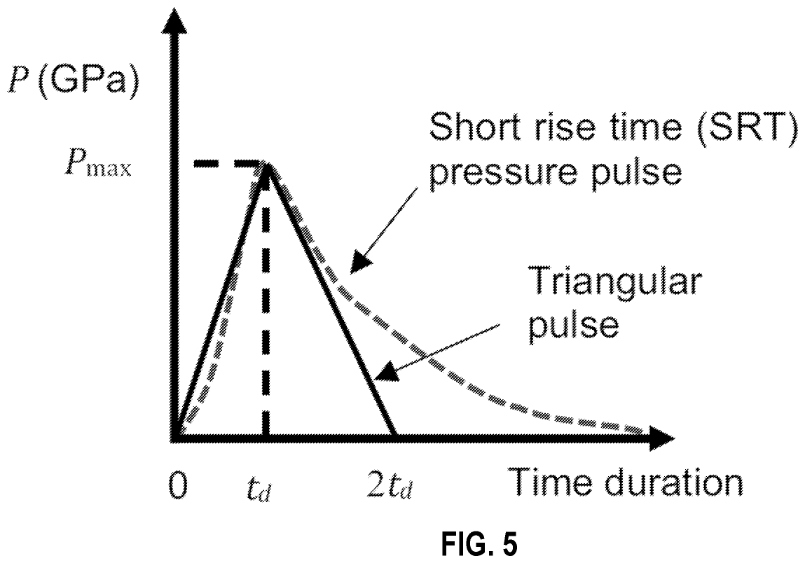

FIG. 5 is a graphical depiction of a pressure-time profile of a single laser peening process. When a laser interacts with a surface, plasma forms and continues to absorb laser energy. Part of this energy is released into the surface as a pressure wave. To simplify laser-material interactions, laser peening can be modeled as a pressure wave that is a function of both radial distance and peening time as follows:

$$P ( r , t ) = P ( t ) exp ( - \frac{{r}^{2}}{2 {R}^{2}} ) \qquad ( 1 )$$

where P(t) is a magnitude of pressure at any time, r is a radial distance from a center of a spot, and R is a spot size. Each of these parameters can affect compressive residual stresses induced in a material. For example, with increase in the laser spot size, a depth of compressive residual stresses increases without a significant difference in magnitude.

Pressure-time history can be defined using a Gaussian temporal profile with a short rise time, as shown in FIG. 5. A triangular pulse can be used because of a narrow pulse duration on an order of several nanoseconds. Since spatial and temporal pressure distributions during LP are neither uniform nor linear, a subroutine DLOAD/VDLOAD can be used to apply non-uniform shock pressure. This subroutine can allow the pressure to vary with respect to both the radius of the laser spot and time.

A common material model to capture high strain rate behavior is Johnson-Cook (JC). An expression for equivalent stress for a given temperature T is given by:

$$\text{?} = ( A + \text{?} ) [ 1 + C ln ( \frac{\text{?}}{\text{?}} ) ] [ \text{?} - ( \frac{T - {T}_{0}}{\text{?} - {T}_{0}} \text{?} ] \qquad ( 2 )$$

$$\text{?} \text{indicates text missing or illegible when filed}$$

where T₀ is a reference temperature, Tₘₑₗₜ is a melting temperature of a material, ε_{eq} is an equivalent plastic strain, e is a plastic strain rate, is a plastic strain rate in a quasi-static state of the material, and A, B, C, n, m are material constants. The JC model can calculate flow stress in the material considering independent effect of strain hardening, strain rate, and temperature while ignoring interdependency of the terms. An internal state variable (ISV) plasticity model can be used for high strain rate-, temperature-, and hardening-dependent constitutive relations. This constitutive model can predict deformation and failure in the material. LP can require a material model that accounts for a dynamic yield stress. Below are corresponding constitutive equations:

$$\text{?} = λ tr ( \text{?} ) \text{?} + 2 μ \text{?} \qquad ( 3 )$$

$$\text{?} = {D}_{-} - \text{?} \qquad ( 4 )$$

$$\text{?} = \int ( T ) sin \text{?} [ \frac{‖ {σ}_{-} - α\_ - ‖ - ( R + Y ( T ) )}{V \text{?}} ] \frac{{σ}_{-} - {α}_{-}}{‖ {σ}_{-} - {α}_{-} ‖} \qquad ( 5 )$$

$$\text{?} = h ( T ) \text{?} - [ \sqrt{\frac{2}{3} \text{?} ( T ) ‖ \text{?} ‖ + \text{?} ( T ) \text{?} ‖ {α}_{-} ‖ {α}_{-}} \qquad ( 6 )$$

$$\text{?} = H ( T ) \text{?} - [ \sqrt{\frac{2}{3} \text{?} ( T ) ‖ \text{?} ‖ + \text{?} ( T ) \text{?} {R}^{2}} \qquad ( 7 )$$

$$\text{?} \text{indicates text missing or illegible when filed}$$

where [symbol] is a flow stress, which is a function of elastic strain D_^{e}. A plastic rate of deformation [symbol] can depend on hardening functions, recovery functions, and yield functions. These functions can be defined as temperature dependent to evaluate interdependency of strain, strain rate, and temperature on a flow stress of the material.

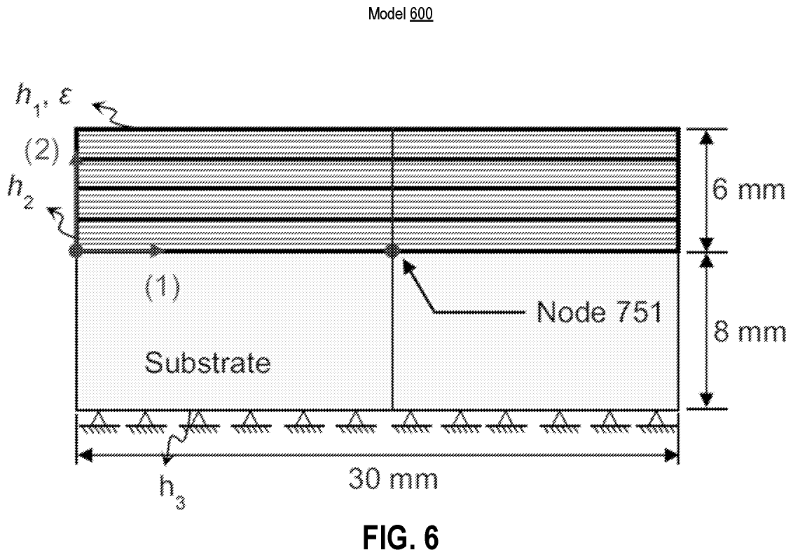

FIG. 6 is a schematic diagram of a hybrid AM model 600 with thermal and mechanical boundary conditions. In the example model 600, a total of 20 layers can be deposited on a substrate, each being 30 mm wide and 0.3 mm thick. The substrate below the layers can have dimensions of 30 mm by 8 mm. Elements in the thermal model can include DC2D4 type, which can represent 4-node diffusive conductive heat transfer elements used to evaluate temperatures developed during application of a moving heat source. Whereas, the elements in stress models can include CPE4, which can represent 4-node bilinear plane strain elements that capture stresses due to the heat source and application of laser peening. Element size in the layers can be 20 μm by 20 μm, and a gradient size can be given to elements in the substrate to minimize computational time. Addition of material during AM can be simulated by means of successive discrete activation of a new set of elements in the model at a beginning of each step (e.g., inactive element method).

Different types of metals can be used for the simulation. For example, AISI 52100 steel can be considered for this simulation for its wide usage in transportation bearings and availability of model constants. In heat transfer analysis, thermo-physical properties can be used to evaluate temperatures. In stress analysis without LP, temperature-dependent elastic and plastic properties (e.g., modulus, ratio, yield strength) can be given along with the temperature-dependent thermal expansion of the material. The plastic properties can be determined and yield strength can be set artificially low above a vaporization temperature. For the stress analysis with LP, internal state variable model (ISV model) can be used.

During heat transfer analysis, a moving heat flux can be applied to simulate temperatures developed in DED on each layer. The heat flux can be modeled as a non-uniform distributed flux as a function of position and time. The heat flux given by the equation below follows Gaussian distribution:

$$q = \frac{CP}{\text{?}} \text{?} \qquad ( 8 )$$

$$\text{?} \text{indicates text missing or illegible when filed}$$

where C is an absorption coefficient, P is laser power in watts, r is a radius of the laser beam in meters, v is scanning speed of heat flux in m/s. As an example, LENS® process parameters can be used to simulate the AM process. Example parameters can include 400 W laser power, 1.36 mm laser spot size, 10 mm/s scan speed, and 30 mm scan length. One or more different parameters can be used to simulate the AM process.

Thermal boundary conditions including conduction, convection, and radiation can be applied to the model. A thermal conduction coefficient (k) can be provided for heat transfer between layers. Heat conducted into the substrate can be given in terms of convection at a bottom of the substrate (h₃=1000 W/(m²·K)). A forced convection and radiation heat transfer boundary conditions can be given on a top surface of each layer while depositing (h₁=100 W/(m²·K), ε=0.62) to account for heat transferred through inert gas blown into a melt pool and through radiation to a surrounding environment. Free convection to the surrounding environment can be given as a boundary condition on edges of layers and substrate (h₂=25 W/(m²·K)).

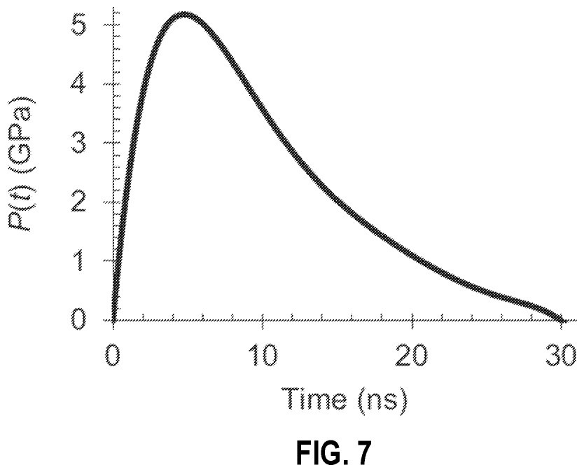

FIG. 7 is a graphical depiction of variation of pressure with respect to time during a laser peening process. A pressure wave from LP can be modeled as a function of radial distance and peening time. The LP process parameters can be chosen to achieve maximum penetration depth of compressive residual stress before reaching a saturation point. Example parameters can include a process duration of 30 ns, 2.25 nm spot size, 5.17 GPa peak pressure, 10 ns pulse duration, 3.59 GW/cm² laser intensity, and 1.42 J laser power.

The pressure varying with peening time can follow a short rise time pulse as shown in FIG. 7. Pressure duration can be three time longer than pulse duration. Glass can be used as a confining layer. Thus, a peak pressure of 5.17 GPa can be applied during laser peening to induce compressive residual stresses into the material. The load can be applied on material for 30 ns in loading step and can be allowed to relax for 10⁻⁴ s. The variation of stresses with time can be shown in FIG. 7.

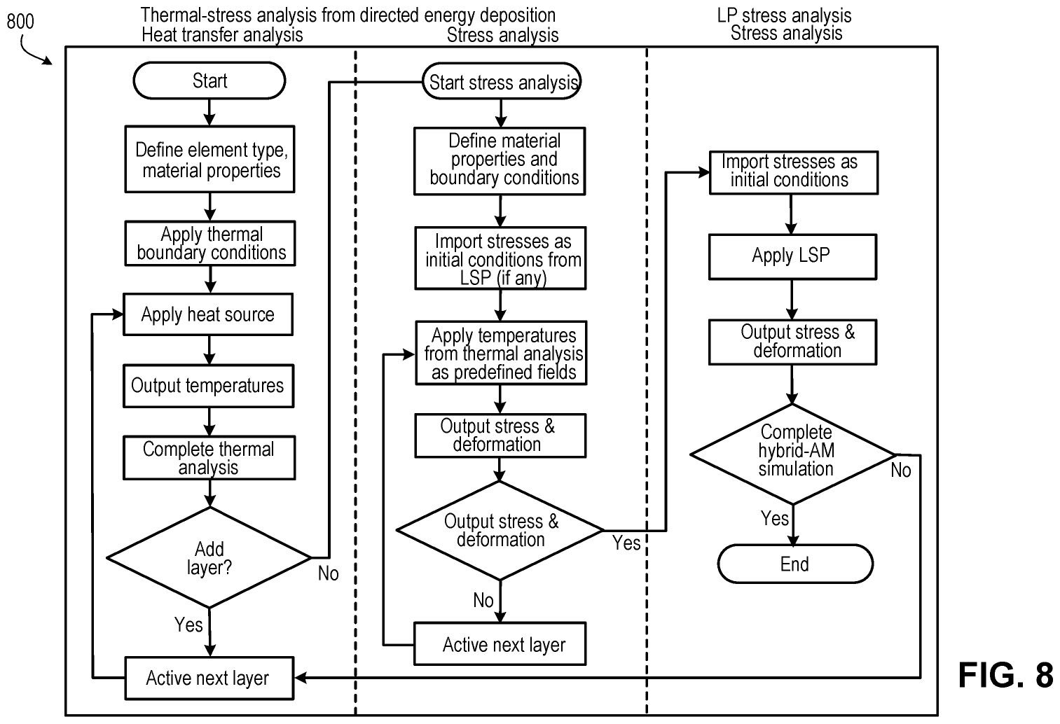

FIG. 8 is a flowchart for a simulation process 800 of hybrid AM by laser peening. In the simulation process 800, two models of identical geometry can be developed: one model for heat transfer analysis with DC2D4 elements and the other for stress analysis with CPE4 elements. The simulation process 800 can include three analyses, including heat transfer analysis from DED, stress analysis from DED, and LP stress analysis.

In the heat transfer analysis, temperatures developed during DED can be computed and imported to a stress analysis. Stresses from the temperatures and LP can then be determined using static/general stress analysis. Thus, the temperatures developed in the heat transfer analysis can be used to calculate stresses from temperatures. In the laser peening analysis, the stresses from adding layers can be imported as initial conditions, and laser peening can be applied completing the first peening cycle. In another next cycle, another set of layers can be added in the heat transfer analysis, and stresses from those temperatures can be calculated with stresses from the previous laser peening as initial conditions followed by laser peening analysis. The same cycle can be repeated until all layers of the part are printed.

In some implementations, laser peening can be performed on every fifth layer that is printed for the part until twenty layers are deposited. In some implementations, there can be four cycles/iterations. Each cycle can contain the heat transfer analysis, stress analysis, and laser peening stress analysis. In the first heat transfer analysis, layers 1-5 can be added one-by-one and heat flux can be applied on each layer to incorporate temperatures generated in an AM process. These temperatures can be exported to the stress analysis of five printed layers to compute stresses. Then, the stresses generated by adding 1-5 layers in the AM process can be imported to the laser peening analysis as initial conditions. In the laser peening analysis, a single laser peening can be applied on the fifth layer and stresses developed can be computed. This can be one of the four cycles of the hybrid AM process.

In a second heat transfer analysis, layers 6-10 can be added one-by-one with heat flux applied on each layer. Then, similar to the previous stress analysis, the temperatures can be imported to evaluate stresses developed, but here along with temperatures, stresses can also be imported from the previous laser peening analysis as initial conditions. This can be beneficial to determine an effect of addition of new layers on a laser peened surface in terms of residual stresses. The stresses from stress analyses of 1-10 printed layers can then be imported as initial conditions and laser peening can be applied on the tenth layer inducing compressive stresses. This can complete the second cycle.

Similarly, layers 11-15 can be added in a third cycle and stresses can be calculated by importing temperatures as predefined fields and stresses from the second laser peening as initial conditions. Laser peening can be applied on the fifteenth layer. Likewise, a final set of layers can be added, and stresses can be computed.

Still referring to FIG. 8, the process 800 can be performed by a computing system. The computing system can include a computer, laptop, tablet, mobile device, cellphone, smart phone, cloud, remote server, or any other similar computer system. Moreover, the process 800 can be performed by a computing system and outputted or displayed in a software tool and/or mobile application. The software tool and/or mobile application can be provided to users in order to understand when and where to apply laser peening during the hybrid AM process. For simplicity and explanatory purposes, the process 800 is described from a perspective of a computing system.

The process 800 can begin in the heat transfer analysis. The computing system can define an element type and material properties. The element type and material properties can indicate how fast a part of that element type and properties can heat up, how fast the heat moves from layer to layer within the part, a melting temperature of the part, and when and where stresses may form in the part.

Next, the computing system can apply thermal boundary conditions. For example, the computing system can determine a temperature of a plate that the part is being built on. The temperature of the plate can indicate thermal boundary conditions for building the part via the simulation process 800.

The computing system can then instruct a heat source to be applied to the part. As described herein, the heat source can be a laser. Thus, heat can be applied to the part.

The computing system can output temperatures of the part. The temperatures can be based on the heat that is applied to the part. The computing system can determine temperatures across one or more existing layers of the part. More specifically, the computing system can determine temperature values for each node of each layer. In some implementations, the computing system can determine temperature values for each layer of the part. In other implementations, the computing system can determine temperature values for selected layers of the part (e.g., a top layer, a bottom layer, and a middle layer).

The computing system can complete thermal analysis and then determine whether to add an additional layer to the part. As described herein, five layers can be added to the part before the computing system moves to the stress analysis. In some implementations, one or more additional or fewer layers can be added to the part before moving to the stress analysis. A user, for example, can provide input or instructions to the computing system indicating a preferred number of layers to add to the part before moving to the stress analysis.

If additional layers should be added to the part, then the computing system can active a next layer for the part. This can include instructing one or more machines to add the additional layer to the existing part. This can also include simulating the addition of the next layer to the part. Once the next layer is added, heat can be applied, temperature can be outputted, and thermal analysis can be completed.

If no additional layers need to be added, the computing system can proceed to starting the stress analysis. At this point, the part can include at least five layers, where each layer is made up of nodes having different temperature values.

In the stress analysis, the computing system can define the material properties and boundary conditions. These values can be constants that can be used to determine how stresses may flow through the part.

The computing system can import stresses, if any, as initial conditions from laser surface peening (e.g., LSP). In other words, if LSP already occurred, stresses identified from that initial LSP process can be imported and used during the stress analysis for the current part. The computing system can therefore determine what the part is like in its granular state, before laser peening begins.

Next, the computing system can apply temperatures from the thermal analysis as predefined fields. The temperatures applied to the part in the previous heat transfer analysis can be applied now. In some implementations, the temperatures can be applied for predefined periods of time. After all, temperature can affect how hard the material of the part is or becomes. In some implementations, applying temperature can include applying stresses to the part.

The computing system can output stresses and deformations. The computing system can calculate and determine the stresses and deformations that occur in the part as a result of applying temperature. Once done, the computing system can determine whether the stress analysis is completed.

If the stress analysis is not complete, then the computing system can activate a next layer of the part, apply temperatures from thermal analysis, and output stress and deformation. In some implementations, stress analysis can be performed for each of the layers of the part. In some implementations, stress analysis can be performed for one or more select layers of the part.

If the stress analysis is compete, the computing system can proceed to the LP stress analysis. The computing system can import the stresses from the stress analysis as initial conditions.

The computing system can then apply LSP to the part. In some implementations, the computing system can instruct one or more machines to apply LSP to the part. In some implementations, the computing system can also simulate applying LSP to the part. Next, the computing system can output stress and deformation of the part that may result from the LSP.

The computing system can determine whether the hybrid AM simulation is complete. If the simulation is complete, the process 800 can end. If the simulation is not complete, the computing system can return to the heat transfer analysis, activate a next layer of the part, and repeat the process 800 described herein.

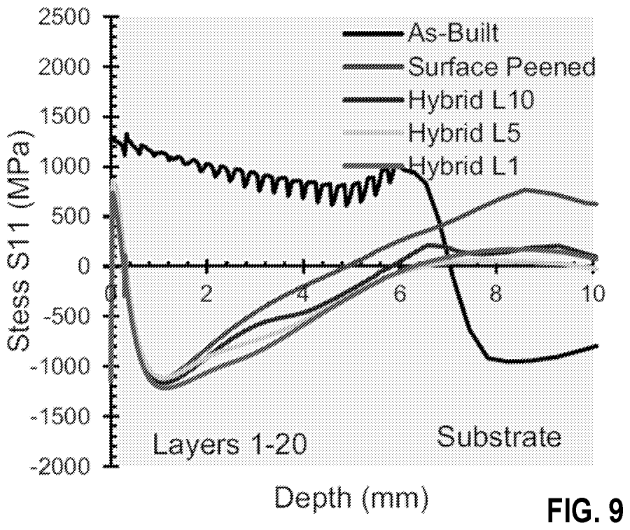

FIG. 9 is a graphical depiction of example stress profile comparisons of hybrid AM models. Five example simulations can be developed in order to demonstrate the disclosed technology. The example simulations can include as-built (no laser peening), laser peening on a surface only (surface peened), laser peening on every 10 layers (hybrid L10), laser peening on every 5 layers (hybrid L5), and laser peening on every layer (hybrid L1). These five cases can be compared to determine an effect of layer peening frequency on stress distribution in layers of a part.

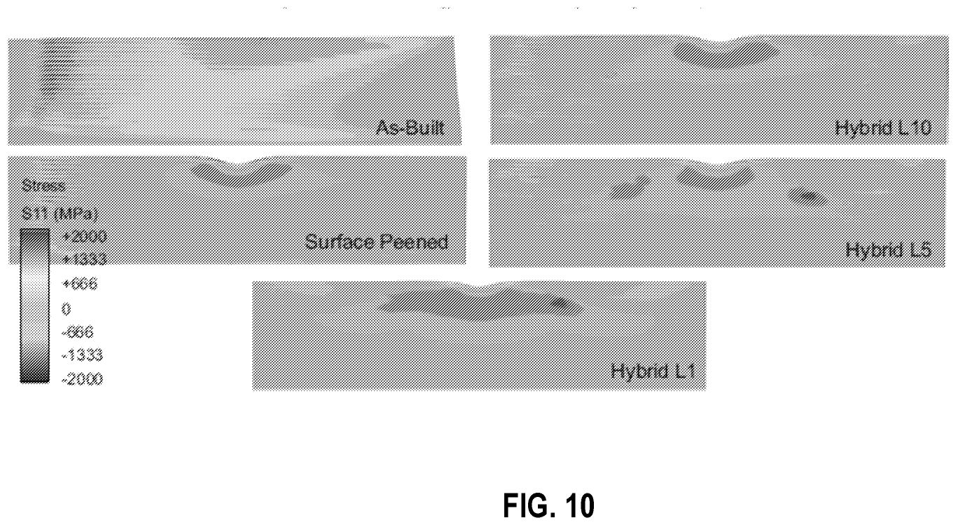

Final residual stresses in direction-1 along a depth for all the models are shown in FIG. 9. Moreover, a full residual stress field map is depicted in FIG. 10 for each condition. The “As-Built” condition represents a stress model of a DED process without any LP. From the plot depicted in FIG. 9, it can be observed that stresses in layers were tensile because of continuous application of heat flux on the layers. This continuous heat flux allowed the material to expand and induce tensile residual stresses in the layers. The magnitude of the stresses in layers varies, as depicted in FIG. 9, from 600 MPa to 1325 MPa.

The stress variation with depth from single laser peening applied on the surface after twenty layers, (e.g., surface peened) is also modeled and depicted for comparison to hybrid conditions. In this case, peening may not be fully coupled; rather, peening can be sequentially coupled as a traditional surface treatment. The tensile stresses from adding layers turned compressive and reached a peak of −1120 MPa. The compressive residual stresses from single laser peening penetrated 4.9 mm before turning tensile.

Three hybrid conditions at different peening frequencies can also be examined, as shown in FIG. 9. Depth of compressive residual stress can increase as peening frequency increases from every ten layers (5.8 mm) to every five layers (6.5 mm). A saturation point can be reached such that further increasing the peening frequency to every layer can decrease the depth to 6.3 mm. Although a saturation point can be reached, higher layer peening frequency can increase a width of a compressive residual stress region. A magnitude of peak compressive stress for all cases, as depicted, can range between −1120 MPa to −1220 MPa.

FIG. 10 illustrates example residual stresses developed in layers in each hybrid AM model of FIG. 9. As stress variation along a line at a center of the model may not represent an entire stress distribution, FIG. 10 illustrates stresses in different models.

To quantify the residual stress distribution, width and depth of compressive residual stresses higher than −650 MPa can be measured. The As-built model had no width or depth to measure. Example measurements are provided. For example, the surface peened model can have a width of 12.2 mm and a depth of 2.5 mm. The hybrid L10 model can have a width of 15.3 mm and a depth of 2.6 mm. The hybrid L5 model can have a width of 16.5 mm and a depth of 3.2 mm. the hybrid L1 model can have a width of 22.1 mm and a depth of 3.7 mm.

As peening frequency increases, the width and depth of residual stress regions also increases. That is, more frequent peening can result in a more sustained compressive residual stress band below the surface of the part.

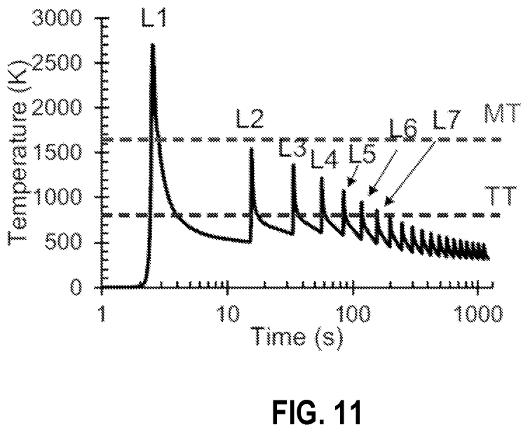

FIG. 11 is a graphical depiction of a temperature profile with time at a top center of a substrate for the hybrid AM models of FIG. 9. Thermal history of a model is crucial for residual stress evolution in the material. Temperatures generated during layer addition can stimulate thermal cancellation of compressive residual stresses developed from laser peening. While modeling the DED process, heat flux can be applied on each layer to simulate temperatures developed during 3D printing of the material part. The temperatures experienced within previously added layers can vary as new layers are deposited.

A node at a top of the material part can be selected to understand a variation of temperatures. At the selected node, temperatures from adding all 20 layers can be calculated, and a temperature variation can be plotted with respect to time as all 20 layers were added, as shown in FIG. 11. As a first layer was added, a peak temperature on top of the material part reached 2700 K. For a second layer, a temperature observed at the node was 1544 K (e.g., as one layer was added, the layer below it experienced near melting temperatures). As layers can be added, a peak temperature experienced by each node can decrease exponentially.

Temperatures above a transition temperature (approximately 820 K) can affect microstructure. A temperature of the selected node can be above the transition temperature until a seventh layer (L7) is added. When an eighth layer is added, the temperature of the selected point dropped below transition temperature (778 K). This can indicate that the heat flux from adding a new layer can affect a microstructure of the seven layers below it.

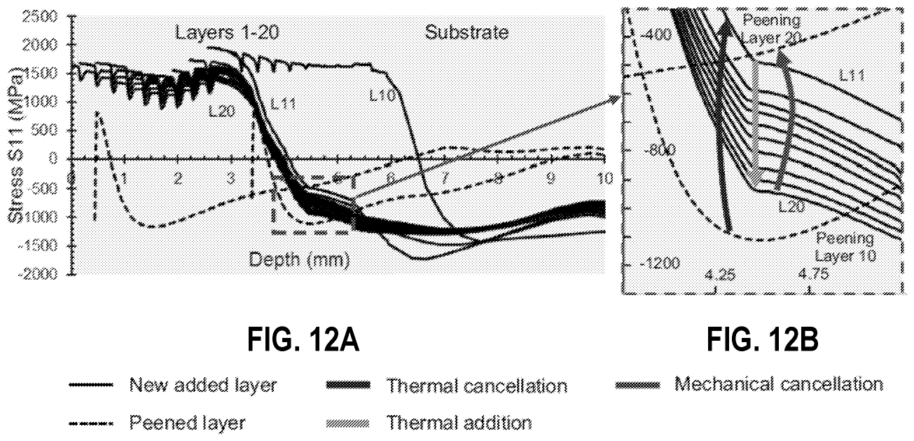

FIGS. 12A-B are graphical depictions of stress profile evolution of a hybrid AM model with laser peening on every 10 layers. As depicted in both FIGS. 12A-B, in hybrid L10, stress development/redistribution in layers is plotted along a depth as layers are added. The stress profile is represented as a solid line when adding a new layer (L10 represents stresses after addition of ten layers), and the laser peened layer is represented with a dotted line (Peening Layer 10: stress profile after printing and laser peening on 10th layer).

In 12A, an L10 curve represents stresses in layers after ten layers are printed. The L10 curve can be similar to the As-built model in FIG. 9, and a maximum tensile stress developed in the layers can be 1900 MPa. Peening layer 10 in FIG. 12B represents the stress profile after laser peening the tenth layer. From this curve, it can be observed that all the tensile stresses present in ten layers can turn compressive after the tenth layer is laser peened, and the peak compressive stress can be −1110 MPa. Then, a new layer (L11) can be added on the laser peened layer (e.g., the tenth layer). In the newly added layer (L11), tensile stresses can be developed as expected from the AM process, however, a peak compressive stress can be reduced from −1100 MPa to −490 MPa in the laser peened layer below it (e.g., the tenth layer). This reduction in compressive stresses when a new layer is added on the laser peened layer is thermal cancellation, as shown in FIG. 12B. Thermal cancellation can result from heat conducted from layer 11 to layer 10 during printing and can cause an expansion and redistribution of compressive stresses in layer 10.

Then, a twelfth layer can be added. Similar to the previous layer (e.g., the eleventh layer), tensile stresses can be developed in L12; however, the compressive stresses can increase from −490 MPa to −590 MPa in the previous laser peened layer, as shown in FIG. 12B. This increase in compressive stress in the laser peened layer can be due to addition of new layers, which is thermal addition. Thermal addition can be attributed to stress re-distribution during the DED process.

As-printed layers can have high tensile stresses. To compensate, compressive stresses can be induced in layers below the printed layer. After all layers are added, there can be a peak tensile stress of 1660 MPa in the newly added layers 11-20 and peak compressive stress of −938 MPa can be observed in previously peened layer (e.g., the tenth layer). Thus, there can be an increase of −448 MPa in the tenth layer due to thermal addition. Next, another laser peening can be applied on layer twenty. This laser peening can induce a peak compressive stress of −1170 MPa. The magnitude of compressive stress in the tenth layer also decreased from −938 MPa to −456 MPa after the twentieth layer was peened. This reduction in compressive stress in layer 10 after the twentieth layer was laser peened is mechanical cancellation. Mechanical cancellation can occur due to a hook shape development of the stress profile from laser peening. This shape of residual stress profile from laser peening can make stresses go tensile after a certain depth. As there exist compressive stresses in the tenth layer, the new laser peening on the twentieth layer can increase a depth of compressive residual stresses. This may be a reason why the depth of compressive stresses in hybrid L10 model was 6.25 mm while it was 4.9 mm in the surface peened model depicted in FIG. 9.

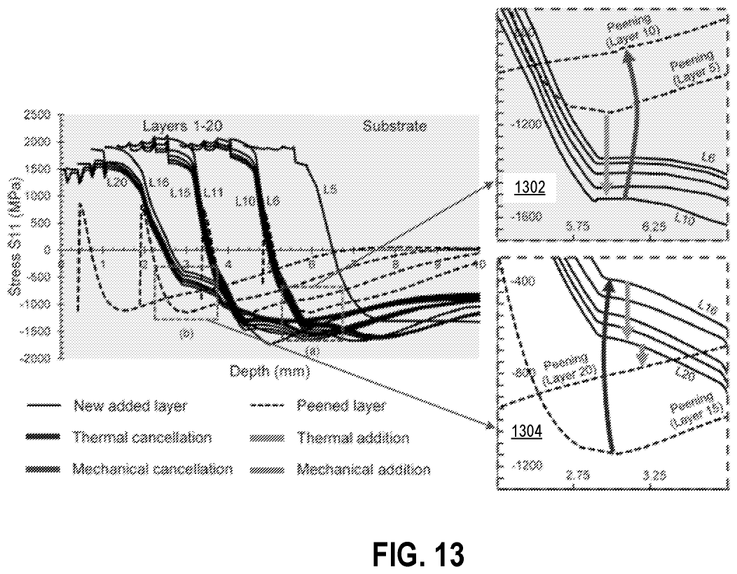

FIG. 13 is a graphical depiction of stress profile evolution of a hybrid AM model with laser peening on every 5 layers. As depicted, 5 layers can be printed and laser peening can be applied on top of the 5th layer. Next, another 5 layers can be added, and laser peening can be applied on a 10th layer. This process can be repeated until all 20 layers are added. FIG. 13 shows stress profile evolution along a depth as new layers are added on a peened surface.

Curve L5 in 1302 represents a stress profile after adding 5 layers. When laser peening is applied on the 5th layer, tensile stresses present in layers 1-5 can turn compressive. In the next step, a 6th layer can be added, and stresses in the 6th layer are tensile as expected; however, the magnitude of compressive stresses in the previously peened layer increased. Instead of thermal cancellation as observed in the hybrid L10 model, thermal addition makes the stresses more compressive at this depth in the L5 model. This thermal addition can continue until the 10th layer is added. When laser peening is applied on the 10th layer, mechanical cancellation can be observed.

A similar trend of thermal addition and mechanical cancellation can be observed for the next cycle depicted in 1304: adding layers 11-15 and laser peening on a 15th layer. In the next step, a 16th layer can be added inducing thermal cancellation in the previous peened layer followed by thermal addition as the layers are added until layer 20. Laser peening can be applied on the 20th layer. Instead of mechanical cancellation, mechanical addition can be observed in the laser peened layer (layer 15). When laser peening is applied on the 20th layer, instead of mechanical cancellation as seen in the previous cycles (L1-5, L6-10, L11-15), mechanical addition can be observed (e.g., refer to 1304). Mechanical addition is defined as addition of compressive stresses in previously peened layers when a newly added layer in the AM process is peened.

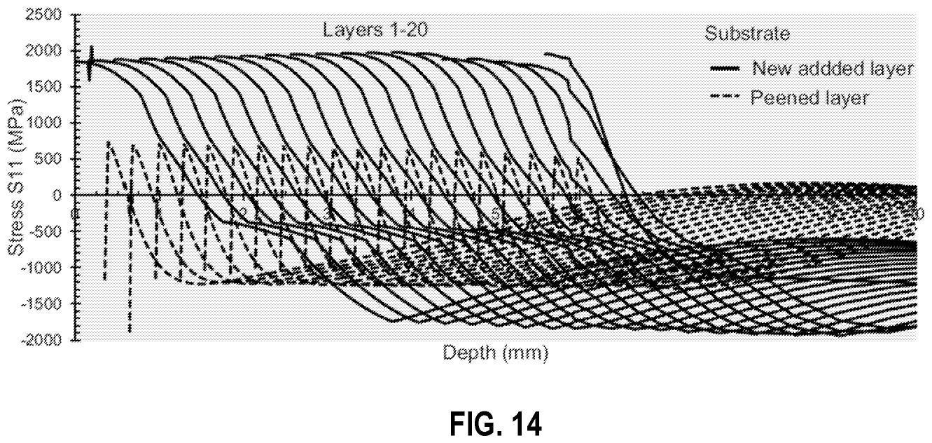

FIG. 14 is a graphical depiction of stress profile evolution of a hybrid AM model with laser peening on every layer. In some implementations, as depicted throughout this disclosure, laser peening can be applied after addition of each layer in DED. When a new layer is added on a peened surface, compressive stresses in previous peened layers can decrease. That is, thermal cancellation can be observed. After laser peening, compressive stresses can increase in the previous peened layers (e.g., mechanical addition can be observed). The same cycle of thermal cancellation and mechanical addition can be observed for all 20 layers. This stress evolution is plotted and depicted in FIG. 14.

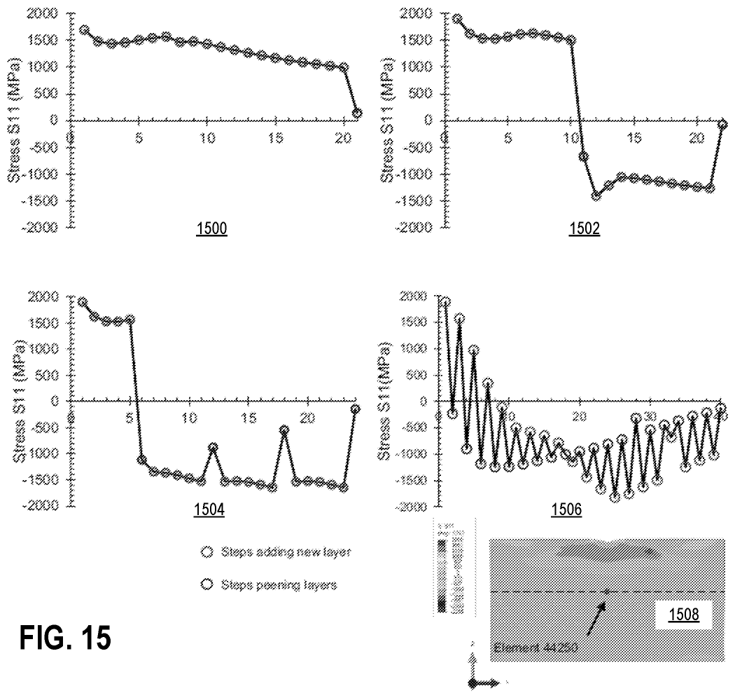

FIG. 15 is a step historic of residual stresses at an element (1508) in surface peened (1500), hybrid AM with laser peening at every 10 layers (1502), hybrid AM with laser peening at every 5 layers (1504), and hybrid AM with laser peening at every layer models (1506). 1508 depicts a location of the element at an interface of a baseplate and build. The graphical depictions described above are local time histories and stress variation with respect to depth in different models. The step histories of these models as depicted in FIG. 15 convey additional information on residual stress reversal.

Each step corresponds to addition of a new layer or laser peening of a layer. For example, hybrid L5 model has 20 layers added and laser peening is applied on layers 5, 10, 15, and 20. This model can have a total of 24 steps with laser peening at steps 6, 12, 18, and 24. Similarly, the models surface peened, hybrid L10, and hybrid L1 can have 21, 22, and 40 steps respectively. To observe the stress variations in an example scenario, element 44,250 can be selected, which is at a top center of a substrate. In FIG. 15, red colored circles indicate stress value after addition of a new layer, and blue colored circles indicate the stress value after a particular layer is peened.

In surface peened model, depicted by 1500, where no laser peening is applied in between layers, stress had minimal variation until peening on the 20th layer in step 21. At this step, the stress is reduced from 993 MPa to 136 MPa, a decrease of 857 MPa. In the hybrid L10 model, depicted in 1502, the stress is tensile until laser peening is applied on layer 10, de-creasing the stress by 2.1 GPa. Beginning with the addition of layer 11, as new layers are added, the stresses stay compressive and can range from −1.4 GPa to −1.2 GPa until another laser peening is applied, changing the stress from −1.2 GPa to −75 MPa. In the hybrid L5 model, as depicted in 1504, the stress variations at the peened steps can be 2.6 GPa, −650 MPa, −1.1 GPa, and −1.5 GPa. In the hybrid L1 model, as depicted in 1506, after addition of a first layer, the stress can be approximately 1900 MPa. After laser peening is applied on it, the stress can drop to −200 MPa. With the application of laser peening, there can be a change in stress of 2.1 GPa. Similarly, change in stress can vary from 2.1 GPa to a few hundreds of megapascals as the first 10 layers are added. Until this point, the newly added layers can induce tensile stresses while laser peening can induce compressive stresses. After the addition of the 11th layer, this trend is reversed. That is, after the addition of layer 11, printing new layers can induce compressive stresses and the stresses due to peening can become tensile. This trend can continue until all remaining layers are added and peened. These variations in stresses from tensile to compressive or vice versa can be observed in all the models described throughout this disclosure. Large reversals in stresses can be due to stress redistributions during the thermal and mechanical cancellations.

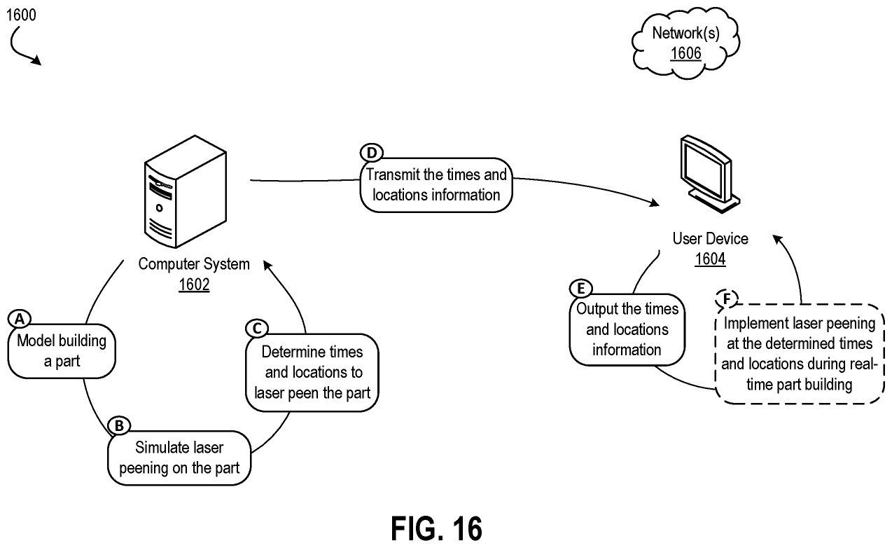

FIG. 16 is a conceptual diagram of a system 1600 for simulating properties of a part formed during an additive manufacturing process. The system 1600 can include a computer system 1602 and a user device 1604 in communication (e.g., wired, wireless) via network(s) 1606. The computer system 1602 can perform any of the techniques, modelling, simulations, and/or real-time generation of parts using additive manufacturing processes described throughout this disclosure.

The computer system 1602 can include one or more computers or servers in data communication. The computer system 1602 can also include one or more cloud services. The user device 1604 can be any one of a computing device, including but not limited to a computer, laptop, tablet, mobile phone, cell phone, or smartphone. In some implementations, the user device 1604 can be part of the computer system 1602.

A user such as a parts manufacturer can use the simulation and modeling techniques described herein via the user device 1604. For example, a software tool or application can be presented at the user device 1604. The software tool or application can present the user with options to simulate modeling a 3D part and simulating properties of the part as it would be formed during an additive manufacturing process (e.g., MAHAM). The software tool or application can also present the user with predicted outcomes associated with simulating the part during the additive manufacturing process. Using the predicted outcomes, the user can make more informed decisions about steps in the additive manufacturing process such that a stronger, more resilient part can be formed.

Referring to the system 1600, the computer system 1602 can model building a part (A). In some implementations, the user can provide input at the user device 1604 indicating initial properties of a material to use for building that part. The user input can also include information about intended properties of the part, such as a strength, use, and shape of the part. Once the part is modelled, the computer system 1602 can simulate laser peening on one or more layers of the modelled part (B). As described throughout this disclosure, simulating the laser peening can be advantageous to determine properties of the part that can result from the laser peening. For example, simulating the laser peening can indicate stresses within a part formed by additive manufacturing and therefore what layers and/or areas of the part (or layers of the part) may be weakened, corroded, or otherwise prone to other design problems. The computer system 1602 can therefore determine times and/or locations to apply laser peening to the modelled part (C). The times and/or locations to apply laser peening can be determined to avoid development of predicted problems during the laser peening process or with the part in after formation. As a result, applying laser peening at the determined times and locations can be beneficial to build stronger and more resilient parts in real-time.

The computer system 1602 can transmit the determined times and locations information to the user device 1604 (D). The times and locations information can be outputted at the user device 1604 (E). For example, the times and locations information can be presented in the software tools and/or applications described herein. The outputted information can include numeric and/or text values. The outputted information can also include visuals and/or graphics demonstrating where and when laser peening can be applied to the part.

Optionally, during real-time building of the part, laser peening can be applied at the determined times and locations (F). In some implementations, the computer system 1602 can automatically implement laser peening at the determined times and locations during real-time building of the part. In some implementations, the computer system 1602 can implement laser peening at the determined times and locations based on approval from the user (e.g., user input received at the user device 1604 that selects or otherwise approves the determined times and locations for laser peening).

As described throughout this disclosure, the user can review the determined locations and times of laser peening to identify changes or improvements in the additive manufacturing process. More specifically, the user can determine how to optimally build the part in real-time to avoid design problems that can otherwise form when laser peening and other secondary processes are used with additive manufacturing techniques.

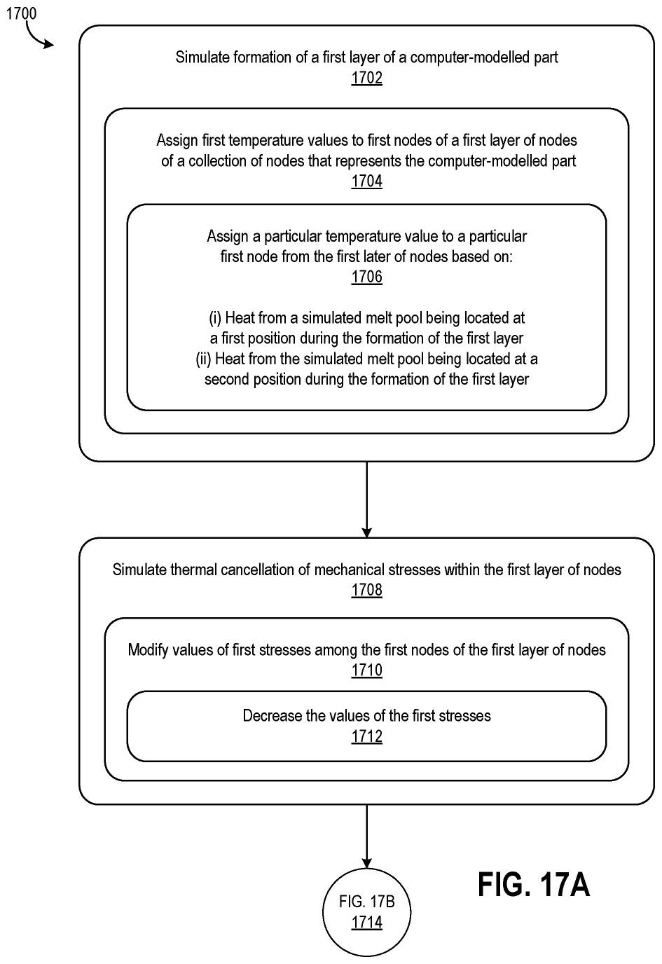

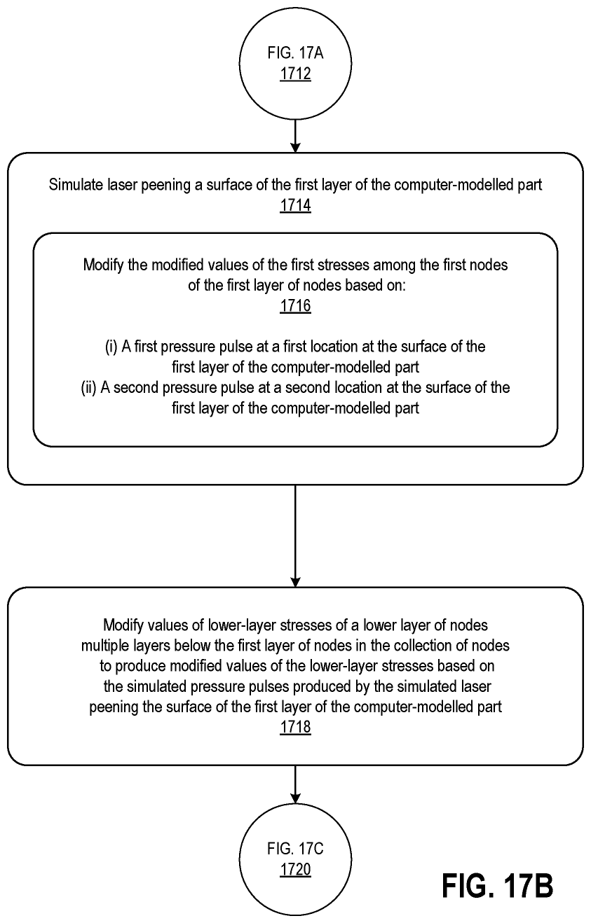

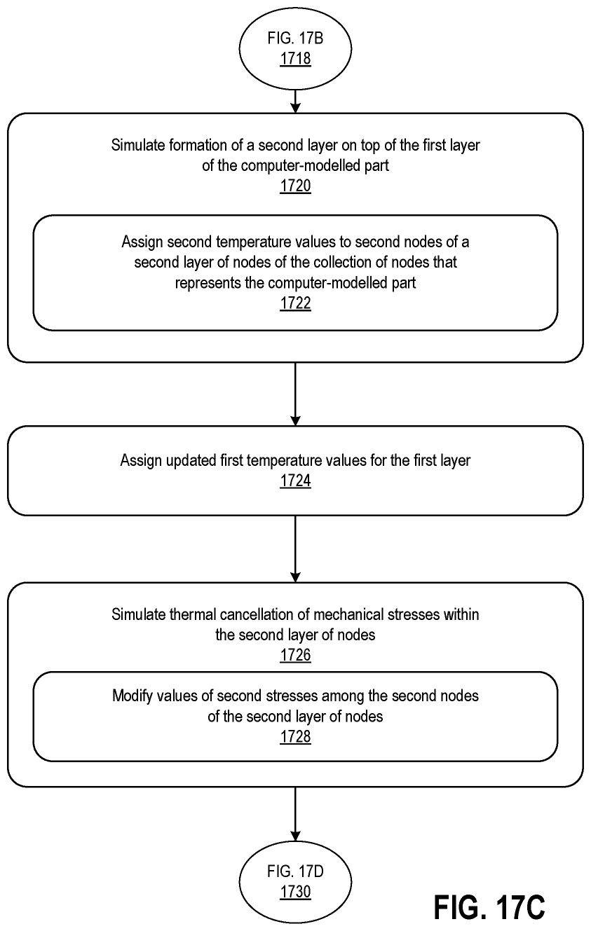

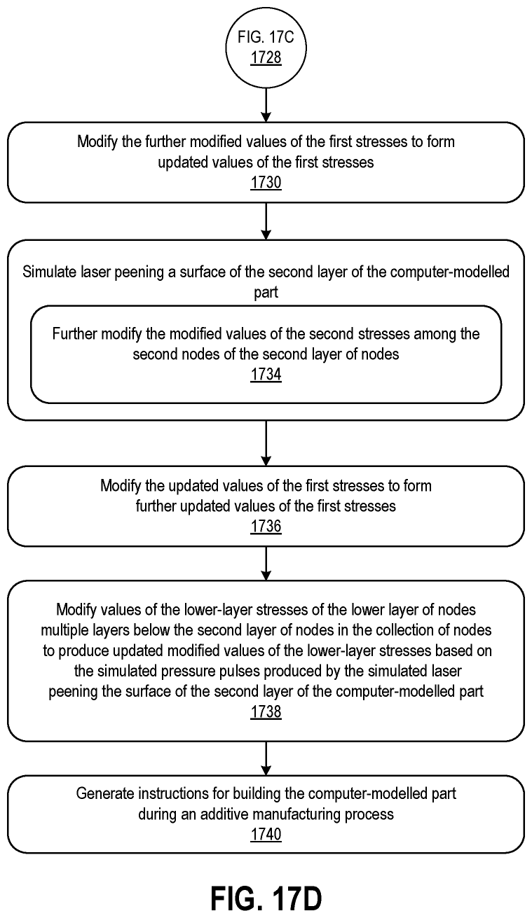

FIGS. 17A-D depict a flowchart of a process 1700 for simulating properties of a part formed during an additive manufacturing process. The process 1700 can be performed by the computer system 1602 (e.g., refer to FIG. 16). The process 1700 can be performed by one or more other computing systems, computers, or servers. For illustrative purposes, the process 1700 is described as being performed from the perspective of the computer system 1602.

Referring to the process 1700 depicted in FIGS. 17A-D, the computer system can simulate formation of a first layer of a computer-modelled part during the additive manufacturing process (1702). The computer system can also assign, to first nodes of a first layer of nodes of a collection of nodes that represents the computer-modelled part, respective first temperature values (1704). Assigning the first temperature values can be based on heat produced by a simulated melt pool created by a high-energy source. The high-energy source can be a laser. Moreover, simulating the formation of the first layer of the computer-modelled part can include the simulated melt pool moving in a pattern to form the first layer of the computer-modelled part.

The computer system can assign a particular temperature value to a particular first node from the first layer of nodes based on (i) heat from the simulated melt pool being located at a first position during the formation of the first layer and (ii) heat from the simulated pool being located at a second position during the formation of the first layer (1706). For example, as the simulated melt pool moves to form a part layer, heat is introduced into multiple different portions of a layer. This heat propagates throughout the layer, such that heat at any given portion of the layer is based on an accumulation of heat from the moving heat pool at different locations.

Next, in 1708, the computer system can simulate thermal cancellation of mechanical stresses within the first layer of nodes. The computer system can also modify values of first stresses among the first nodes of the first layer of nodes (1710). The computer system can modify the values of the first stresses based on the first temperature values of the first layer of nodes. Modifying the values can also include decreasing, by the computer system, the values of the first stresses to form the modified values of the first stresses (1712). For example, the heat present in the layer can thermally cancel (e.g., reduce) mechanical stresses previously present within the first layer, just as heating metal with a blow torch can soften the metal. The modified values of the first stresses can be in tension, which can result from heat produced by the simulated melt pool causing the material to expand.

The computer system can then simulate laser peening a surface of the first layer of the computer-modelled part in 1714. Simulating laser peening the surface can include modifying the modified values of the first stresses among the first nodes of the first layer of nodes to form further modified values of the first stresses (1716). Further modifying the modified values can be based on simulated pressure pulses produced by the simulated laser peening of the surface of the first layer of the computer-modelled part. For example, the simulation can involve simulating pressure pulses on a top surface of the additive-manufactured part, and modifying strain values at least partially throughout the part based on each applied pressure pulse.

The further modified values can based on (i) a first pressure pulse at a first location at the surface of the first layer of the computer-modelled part, and (ii) a second pressure pulse at a second location at the surface of the first layer of the computer-modelled part. As a result, a particular stress of the first stresses can have a further modified value that is based on both the first pressure pulse and the second pressure pulse. This is because a strain value of a strain at a given location in a part is based on pressure pulses at multiple locations that are proximal the given location. An effect of the first pressure pulse on the particular stress can be based on a first distance from the particular stress to the first location. An effect of the second pressure pulse on the particular stress can be based on a second distance from the particular stress to the second location. The second distance can be different from the first distance. Moreover, the further modified values of the first stresses can be in compression, which can result from the simulated pressure pulses. Thus, stresses that were in tension due to heat from the simulated heat pool may transition to being in compression due to the simulated pressure pulses.

The computer system can modify values of lower-layer stresses of a lower layer of nodes multiple layers below the first layer of nodes in the collection of nodes to produce modified values of the lower-layer stresses (1718). The computer system can modify the values of the lower-layer stresses based on the simulated pressure pulses produced by the simulated laser peening the surface of the first layer of the computer-modelled part. The modified values of the lower-layer stresses can be lower than the values of the lower-layer stresses due to mechanical cancellation of the lower-layer stresses. For example, as a top surface of the part is laser peened, the pressure pulses can increase the values of stresses near the top surface to place those stresses in compression, but stresses located several layers below the top surface can decrease due to mechanical cancellation resulting from the simulated pressure pulses.

In 1720, the computer system can simulate formation of a second layer on top of the first layer of the computer-modelled part. Simulating formation of the second layer can include assigning second temperature values to second nodes of a second layer of nodes of the collection of nodes that represents the computer-modelled part (1722). The respective second temperature values can be based on heat produced by the simulated melt pool during formation of the second layer.

The computer system can assign updated first temperature values for the first layer in 1724. Assigning the updated first temperature values can be based on heat produced by the simulated melt pool during formation of the second layer. For example, the heat from forming the second layer can introduce heat not only into the second layer, but also the first layer that is below it (the first layer can be adjacent the second layer or separated from the second layer by one or more intermediate layers).

In 1726, the computer system can simulate thermal cancellation of mechanical stresses within the second layer of nodes. This can include modifying values of second stresses among the second nodes of the second layer of nodes (1728). Modifying the values of the second stresses can be based on the second temperature values of the second layer of nodes.

Next, after simulating the formation of the second layer, the computer system can modify the further modified values of the first stresses to form updated values of the first stresses (1730). The further modified values can be based on the further modified values of the first stresses and heat produced by the simulated melt pool during formation of the second layer. For example, the newly-updated heat values can reduce stresses present in the first layer, and that were increased by previous laser peening.

The computer system can simulate laser peening a surface of the second layer of the computer-modelled part in 1732. This can include further modifying the modified values of the second stresses among the second nodes of the second layer of nodes to form further modified values of the second stresses (1734). Further modifying the modified values of the second stresses can be based on simulated pressure pulses produced by the simulated laser peening the surface of the second layer of the computer-modelled part.

After simulating the formation of the second layer, the computer system can also modify the updated values of the first stresses to form further updated values of the first stresses (1736). The further updated values can be based on the updated values of the first stresses and simulated pressure pulses produced by the simulated laser peening of the surface of the second layer of the computer-modelled part.

The computer system can also modify values of the lower-layer stresses of the lower layer of nodes multiple layers below the second layer of nodes in the collection of nodes to produce updated modified values of the lower-layer stresses (1738). The values of the lower-layer stresses can be modified based on the simulated pressure pulses produced by the simulated laser peening the surface of the second layer of the computer-modelled part.

The computer system can generate instructions for building the computer-modelled part during an additive manufacturing process in 1740. The instructions can be generated based on the above-described simulating the properties of the computer-modelled part. The instructions can, for example, indicate to a user, such as a manufacturer, where and when laser peening can be applied to a surface of the part. For example, the instructions can indicate that laser peening should be applied to a particular portion of a particular layer at a particular time during the real-time additive manufacturing process. Such instructions can be advantageous because laser peening (or other secondary processes) may not have to be applied to an entire surface of a layer, which can help mitigate or prevent problems such as corrosion.

The process 1700 describes simulating formation of two layers on the computer-modelled part, however it can be realized that the process 1700 can be used to simulate formation of fewer and/or additional layers on the computer-modeled part. In some implementations, the computer system can repeat one or more blocks of the process 1700 to simulate more than two layers. For example, the computer system can simulate forming a user-defined number of layers of the computer-modelled part. The computer system can also simulate forming a user-defined number of layers of the computer-modelled part but simulate laser peening on only one or more of those layers. For example, laser peening can be simulated on a surface of every layer, every 5 layers, every 10 layers, etc. Indeed, the above description of laser peening a first layer and then laser peening a second laser is meant to describe a situation in which multiple layers are formed between the first layer and the second layer. A user can define intervals to simulate applying laser peening. In some implementations, the computer system can determine optimal layers at which to simulate application of laser peening.

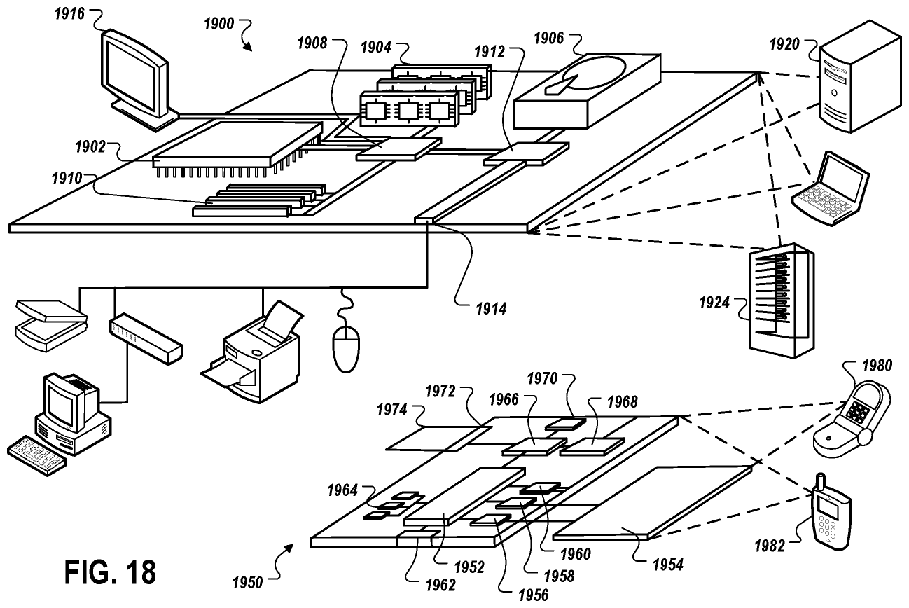

FIG. 18 shows an example of a computing device 1900 and an example of a mobile computing device that can be used to implement the techniques described here. The computing device 1900 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 1900 includes a processor 1902, a memory 1904, a storage device 1906, a high-speed interface 1908 connecting to the memory 1904 and multiple high-speed expansion ports 1910, and a low-speed interface 1912 connecting to a low-speed expansion port 1914 and the storage device 1906. Each of the processor 1902, the memory 1904, the storage device 1906, the high-speed interface 1908, the high-speed expansion ports 1910, and the low-speed interface 1912, are interconnected using various busses, and can be mounted on a common motherboard or in other manners as appropriate. The processor 1902 can process instructions for execution within the computing device 1900, including instructions stored in the memory 1904 or on the storage device 1906 to display graphical information for a GUI on an external input/output device, such as a display 1916 coupled to the high-speed interface 1908. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 1904 stores information within the computing device 1900. In some implementations, the memory 1904 is a volatile memory unit or units. In some implementations, the memory 1904 is a non-volatile memory unit or units. The memory 1904 can also be another form of computer-readable medium, such as a magnetic or optical disk.

The storage device 1906 is capable of providing mass storage for the computing device 1900. In some implementations, the storage device 1906 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 1904, the storage device 1906, or memory on the processor 1902.

The high-speed interface 1908 manages bandwidth-intensive operations for the computing device 1900, while the low-speed interface 1912 manages lower bandwidth-intensive operations. Such allocation of functions is exemplary only. In some implementations, the high-speed interface 1908 is coupled to the memory 1904, the display 1916 (e.g., through a graphics processor or accelerator), and to the high-speed expansion ports 1910, which can accept various expansion cards (not shown). In the implementation, the low-speed interface 1912 is coupled to the storage device 1906 and the low-speed expansion port 1914. The low-speed expansion port 1914, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 1900 can be implemented in a number of different forms, as shown in the figure. For example, it can be implemented as a standard server 1920, or multiple times in a group of such servers. In addition, it can be implemented in a personal computer such as a laptop computer 1922. It can also be implemented as part of a rack server system 1924. Alternatively, components from the computing device 1900 can be combined with other components in a mobile device (not shown), such as a mobile computing device 1950. Each of such devices can contain one or more of the computing device 1900 and the mobile computing device 1950, and an entire system can be made up of multiple computing devices communicating with each other.

The mobile computing device 1950 includes a processor 1952, a memory 1964, an input/output device such as a display 1954, a communication interface 1966, and a transceiver 1968, among other components. The mobile computing device 1950 can also be provided with a storage device, such as a micro-drive or other device, to provide additional storage. Each of the processor 1952, the memory 1964, the display 1954, the communication interface 1966, and the transceiver 1968, are interconnected using various buses, and several of the components can be mounted on a common motherboard or in other manners as appropriate.

The processor 1952 can execute instructions within the mobile computing device 1950, including instructions stored in the memory 1964. The processor 1952 can be implemented as a chipset of chips that include separate and multiple analog and digital processors. The processor 1952 can provide, for example, for coordination of the other components of the mobile computing device 1950, such as control of user interfaces, applications run by the mobile computing device 1950, and wireless communication by the mobile computing device 1950.

The processor 1952 can communicate with a user through a control interface 1358 and a display interface 1956 coupled to the display 1954. The display 1954 can be, for example, a TFT (Thin-Film-Transistor Liquid Crystal Display) display or an OLED (Organic Light Emitting Diode) display, or other appropriate display technology. The display interface 1956 can comprise appropriate circuitry for driving the display 1954 to present graphical and other information to a user. The control interface 1958 can receive commands from a user and convert them for submission to the processor 1952. In addition, an external interface 1962 can provide communication with the processor 1952, so as to enable near area communication of the mobile computing device 1950 with other devices. The external interface 1962 can provide, for example, for wired communication in some implementations, or for wireless communication in other implementations, and multiple interfaces can also be used.

The memory 1964 stores information within the mobile computing device 1950. The memory 1964 can be implemented as one or more of a computer-readable medium or media, a volatile memory unit or units, or a non-volatile memory unit or units. An expansion memory 1974 can also be provided and connected to the mobile computing device 1950 through an expansion interface 1972, which can include, for example, a SIMM (Single In Line Memory Module) card interface. The expansion memory 1974 can provide extra storage space for the mobile computing device 1950, or can also store applications or other information for the mobile computing device 1950. Specifically, the expansion memory 1974 can include instructions to carry out or supplement the processes described above, and can include secure information also. Thus, for example, the expansion memory 1974 can be provide as a security module for the mobile computing device 1950, and can be programmed with instructions that permit secure use of the mobile computing device 1950. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 1964, the expansion memory 1974, or memory on the processor 1952. In some implementations, the computer program product can be received in a propagated signal, for example, over the transceiver 1968 or the external interface 1962.

The mobile computing device 1950 can communicate wirelessly through the communication interface 1966, which can include digital signal processing circuitry where necessary. The communication interface 1966 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 1968 using a radio-frequency. In addition, short-range communication can occur, such as using a Bluetooth, WiFi, or other such transceiver (not shown). In addition, a GPS (Global Positioning System) receiver module 1970 can provide additional navigation- and location-related wireless data to the mobile computing device 1950, which can be used as appropriate by applications running on the mobile computing device 1950.

The mobile computing device 1950 can also communicate audibly using an audio codec 1960, which can receive spoken information from a user and convert it to usable digital information. The audio codec 1960 can likewise generate audible sound for a user, such as through a speaker, e.g., in a handset of the mobile computing device 1950. Such sound can include sound from voice telephone calls, can include recorded sound (e.g., voice messages, music files, etc.) and can also include sound generated by applications operating on the mobile computing device 1950.

The mobile computing device 1950 can be implemented in a number of different forms, as shown in the figure. For example, it can be implemented as a cellular telephone 1980. It can also be implemented as part of a smart-phone 1982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

As described throughout this disclosure, from 2D finite element model of hybrid AM by DED and laser processing, layer-by-layer peening during AM can induce compressive residual stresses in a part that are not completely cancelled from heat or mechanical redistribution. Critical hybrid process parameters can be identified, such as layer peening frequency, peening intensity (e.g., laser power and spot size), and layer thickness. Decreasing layer peening frequency (e.g., peening more frequently) from 20 to 5 can increase a depth of compressive residual stresses (CRS). In an example modeling scenario where layer thickness is 0.3 mm, depth of CRS saturated below a peening frequency of every 5 layers. That is, peening more frequently than every five layers may not increase the depth of CRS. In single peening mode, a peak CRS below the surface was similar (±100 MPa) for all layer peening frequencies. Width and thickness of the CRS, referred to as a CRS band, increased with more frequent layer peening. Peening every layer can result in the widest and thickest CRS band. These results can indicate that peening fewer layers with multiple peenings can be equivalent to peening every layer with a single peening. Multiple peenings can increase the width and thickness of the CRS band.

As another example scenario, stress profile evolution in a model with a layer peening frequency of 10 can exhibit thermal cancellation, thermal addition, and mechanical cancellation. When peening every 5 layers, in layers 5 and 10, thermal addition and mechanical cancellation can be observed. In layer 15, thermal cancellation and mechanical addition can be observed. No mechanical cancellation may observed when peening every layer. This can be due to a high peening frequency. The depth of the peak CRS from peening layers can reach previously peened layers below and can result in an increased CRS. This indicates complex residual stress histories exist that can be dependent on a location in the part. Understanding these histories may be important in designing parts for performance. In steels, reversals in stress from thermal and mechanical cancellation can range from 100's of megapascals to a few gigapascals. Hybrid processing of a steel part can result in short cycle fatigue failure when coupling printing and peening because of the dramatic reversals in CRS. Thus, the present disclosure provides tools to assist users, such as manufacturers, in building stronger metal parts based on where and when laser peening can be applied during the hybrid AM process.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

1. A computer-implemented method for simulating properties of a part formed during additive manufacturing, the method comprising:
simulating, by a computing system, formation of a first layer of a computer-modelled part during an additive manufacturing process, including by assigning, to first nodes of a first layer of nodes of a collection of nodes that represents the computer-modelled part, respective first temperature values based on heat produced by a simulated melt pool created by a high-energy source;
simulating, by the computing system, thermal cancellation of mechanical stresses within the first layer of nodes, including by modifying values of first stresses among the first nodes of the first layer of nodes based on the first temperature values of the first layer of nodes to form modified values of the first stresses;
simulating, by the computing system, laser peening a surface of the first layer of the computer-modelled part, including by modifying the modified values of the first stresses among the first nodes of the first layer of nodes to form further modified values of the first stresses based on simulated pressure pulses produced by the simulated laser peening of the surface of the first layer of the computer-modelled part; and
generating, by the computing system, instructions for building the computer-modelled part during a real-world additive manufacturing process based on the simulating of the formation of the first layer of the computer-modelled part and the simulating of the laser pending of the surface of the first layer of the computer-modelled part.

2. The computer-implemented method of claim 1, wherein assigning the first temperature values to the first nodes of the first layer of nodes includes assigning a particular temperature value to a particular first node from the first layer of nodes based on:
heat from the simulated melt pool being located at a first position during the formation of the first layer; and
heat from the simulated melt pool being located at a second position during the formation of the first layer.

3. The computer-implemented method of claim 1, wherein simulating the formation of the first layer of the computer-modelled part includes the simulated melt pool moving in a pattern to form the first layer of the computer-modelled part.

4. The computer-implemented method of claim 1, wherein modifying the values of the first stresses among the first nodes of the first layer of nodes includes decreasing the values of the first stresses to form the modified values of the first stresses.

5. The computer-implemented method of claim 1, wherein modifying the modified values of the first stresses includes to form the further modified values of the first stresses is based on (i) a first pressure pulse at a first location at the surface of the first layer of the computer-modelled part, and (ii) a second pressure pulse at a second location at the surface of the first layer of the computer-modelled part, such that a particular stress of the first stresses has a further modified value that is based on both the first pressure pulse and the second pressure pulse.

6. The computer-implemented method of claim 5, wherein:
an effect of the first pressure pulse on the particular stress is based on a first distance from the particular stress to the first location; and
an effect of the second pressure pulse on the particular stress is based on a second distance from the particular stress to the second location, the second distance being different from the first distance.

7. The computer-implemented method of claim 1, wherein:
the modified values of the first stresses are in tension, resulting from heat produced by the simulated melt pool; and
the further modified values of the first stresses are in compression, resulting from the simulated pressure pulses.

8. The computer-implemented method of claim 1, comprising:
simulating, by the computing system, formation of a second layer of the computer-modelled part on top of the first layer of the computer-modelled part, including by assigning, to second nodes of a second layer of nodes of the collection of nodes that represents the computer-modelled part, respective second temperature values based on heat produced by the simulated melt pool during formation of the second layer;
simulating, by the computing system, thermal cancellation of mechanical stresses within the second layer of nodes, including by modifying values of second stresses among the second nodes of the second layer of nodes based on the second temperature values of the second layer of nodes to form modified values of the second stresses; and
simulating, by the computing system, laser peening a surface of the second layer of the computer-modelled part, including by further modifying the modified values of the second stresses among the second nodes of the second layer of nodes to form further modified values of the second stresses based on simulated pressure pulses produced by the simulated laser peening of the surface of the second layer of the computer-modelled part.

9. The computer-implemented method of claim 8, comprising:
assigning, by the computing system after simulating the formation of the second layer, updated first temperature values for the first layer based on heat produced by the simulated melt pool during formation of the second layer;
modifying, by the computing system after simulating the formation of the second layer, the further modified values of the first stresses to form updated values of the first stresses, based on:
(i) the further modified values of the first stresses, and
(ii) heat produced by the simulated melt pool during formation of the second layer; and
modifying, by the computing system after simulating the formation of the second layer, the updated values of the first stresses to form further updated values of the first stresses based on:
(i) the updated values of the first stresses, and
(ii) simulated pressure pulses produced by the simulated laser peening of the surface of the second layer of the computer-modelled part.

10. The computer-implemented method of claim 1, comprising modifying values of lower-layer stresses of a lower layer of nodes multiple layers below the first layer of nodes in the collection of nodes to produce modified values of the lower-layer stresses, based on the simulated pressure pulses produced by the simulated laser peening of the surface of the first layer of the computer-modelled part, wherein the modified values of the lower-layer stresses are lower than the values of the lower-layer stresses due to mechanical cancellation of the lower-layer stresses resulting from the simulated laser peening of the surface of the first layer of the computer-modelled part.

11. A computerized system for simulating properties of a part formed during an additive manufacturing process, the system comprising:
one or more processors; and
one or more computer-readable devices including instructions that, when executed by the one or more processors, cause the computerized system to perform operations that include:
simulating formation of a first layer of a computer-modelled part during an additive manufacturing process, including by assigning, to first nodes of a first layer of nodes of a collection of nodes that represents the computer-modelled part, respective first temperature values based on heat produced by a simulated melt pool created by a high-energy source;
simulating thermal cancellation of mechanical stresses within the first layer of nodes, including by modifying values of first stresses among the first nodes of the first layer of nodes based on the first temperature values of the first layer of nodes to form modified values of the first stresses;
simulating laser peening a surface of the first layer of the computer-modelled part, including by modifying the modified values of the first stresses among the first nodes of the first layer of nodes to form further modified values of the first stresses based on simulated pressure pulses produced by the simulated laser peening of the surface of the first layer of the computer-modelled part; and
generating instructions for building the computer-modelled part during a real-world additive manufacturing process based on the simulating of the formation of the first layer of the computer-modelled part and the simulating of the laser pending of the surface of the first layer of the computer-modelled part.

12. The system of claim 11, wherein assigning the first temperature values to the first nodes of the first layer of nodes includes assigning a particular temperature value to a particular first node from the first layer of nodes based on:
heat from the simulated melt pool being located at a first position during the formation of the first layer; and
heat from the simulated melt pool being located at a second position during the formation of the first layer.

13. The system of claim 11, wherein simulating the formation of the first layer of the computer-modelled part includes the simulated melt pool moving in a pattern to form the first layer of the computer-modelled part.

14. The system of claim 11, wherein modifying the values of the first stresses among the first nodes of the first layer of nodes includes decreasing the values of the first stresses to form the modified values of the first stresses.

15. The system of claim 11, wherein modifying the modified values of the first stresses includes to form the further modified values of the first stresses is based on (i) a first pressure pulse at a first location at the surface of the first layer of the computer-modelled part, and (ii) a second pressure pulse at a second location at the surface of the first layer of the computer-modelled part, such that a particular stress of the first stresses has a further modified value that is based on both the first pressure pulse and the second pressure pulse.

16. The system of claim 15, wherein:
an effect of the first pressure pulse on the particular stress is based on a first distance from the particular stress to the first location; and
an effect of the second pressure pulse on the particular stress is based on a second distance from the particular stress to the second location, the second distance being different from the first distance.

17. The system of claim 11, wherein:
the modified values of the first stresses are in tension, resulting from heat produced by the simulated melt pool; and
the further modified values of the first stresses are in compression, resulting from the simulated pressure pulses.

18. The system of claim 11, wherein the computerized system is further configured to perform operations that include:
simulating formation of a second layer of the computer-modelled part on top of the first layer of the computer-modelled part, including by assigning, to second nodes of a second layer of nodes of the collection of nodes that represents the computer-modelled part, respective second temperature values based on heat produced by the simulated melt pool during formation of the second layer;
simulating thermal cancellation of mechanical stresses within the second layer of nodes, including by modifying values of second stresses among the second nodes of the second layer of nodes based on the second temperature values of the second layer of nodes to form modified values of the second stresses; and
simulating laser peening a surface of the second layer of the computer-modelled part, including by further modifying the modified values of the second stresses among the second nodes of the second layer of nodes to form further modified values of the second stresses based on simulated pressure pulses produced by the simulated laser peening of the surface of the second layer of the computer-modelled part.

19. The system of claim 18, wherein the computerized system is further configured to perform operations that include:
assigning, after simulating the formation of the second layer, updated first temperature values for the first layer based on heat produced by the simulated melt pool during formation of the second layer;
modifying, after simulating the formation of the second layer, the further modified values of the first stresses to form updated values of the first stresses, based on:
(i) the further modified values of the first stresses, and
(ii) heat produced by the simulated melt pool during formation of the second layer; and
modifying, after simulating the formation of the second layer, the updated values of the first stresses to form further updated values of the first stresses based on:
(i) the updated values of the first stresses, and
(ii) simulated pressure pulses produced by the simulated laser peening of the surface of the second layer of the computer-modelled part.

20. The system of claim 11, wherein the computerized system is further configured to perform operations that include modifying values of lower-layer stresses of a lower layer of nodes multiple layers below the first layer of nodes in the collection of nodes to produce modified values of the lower-layer stresses, based on the simulated pressure pulses produced by the simulated laser peening of the surface of the first layer of the computer-modelled part, wherein the modified values of the lower-layer stresses are lower than the values of the lower-layer stresses due to mechanical cancellation of the lower-layer stresses resulting from the simulated laser peening of the surface of the first layer of the computer-modelled part.
